(19) United States
(12) Patent Application Publication
(10) Pub. No.: US 2026/0265590 A1
(43) Pub. Date: Sep. 10, 2026

(54) COMPOSITION INCLUDING ACRYLIC POLYMER AND TACKIFIER AND RELATED METHODS

(71) Applicant: 3M INNOVATIVE PROPERTIES COMPANY, St. Paul, MI (US)

(72) Inventors: Lili Qie, Woodbury, MI (US); Dillon S. Gentekos, St. Paul, MI (US); Kumars Sakizadeh, Woodbury, MI (US); Ying Zhang, Woodbury, MI (US); Chi-Ming Tseng, Woodbury, MI (US); Jayshree Seth, Woodbury, MI (US)

(21) Appl. No.: 19/491,289

(22) PCT Filed: Jun. 17, 2024
(86) PCT No.: PCT/US2024/034375

§ 371 Date: Dec. 8, 2025

Related U.S. Application Data
(60) Provisional application No. 63/521,330, filed on Jun. 15, 2023.

(51) Int. Cl. C09J 151/00; B05D 1/02; C08F 2/26; C08F 2/38; C08F 2/44; C08F 2/50; C08F 265/06; C08K 5/37

(52) U.S. Cl. CPC C09J 151/003; B05D 1/02; C08F 2/26; C08F 2/44; C08F 2/50; C08F 265/06; C08K 5/37; B05D 2401/20; B05D 2502/00; C08F 2/38

(57) ABSTRACT

A composition includes an acrylic polymer, a tackifier, an emulsifier, and water. The acrylic polymer includes monomer units of at least one alkyl acrylate or alkyl methacrylate, wherein alkyl has at least 8 or at least 10 carbon atoms and at least 0.5 percent by weight of monomer units comprising a carboxylic acid, sulfonic acid, or phosphonic acid, based on the total weight of monomer units in the acrylic polymer. The acrylic polymer may include additional monomer units of at least one of a C₄-C₉ alkyl acrylate or C₄-C₉ alkyl methacrylate or third monomer units of a high T_{g} monomer that when polymerized provides a homopolymer having a glass transition temperature of at least 20° C. The composition may include a second tackifier. A process for making the composition and a method for making a bonded article using the composition are also described.

### BACKGROUND

Pressure-sensitive adhesives (often referred to as PSAs) are useful for a variety of purposes. Applying PSAs may involve applying an adhesive polymer composition in organic solvent or as an oil-in-water emulsion onto a substrate and subsequently removing the solvent or water. Water-based adhesives have significant advantages over their traditional solvent borne counterparts in that they can have low or no volatile organic compounds and can be nonflammable.

U.S. Pat. No. 6,710,128 (Helmer et al.) and U.S. Pat. Appl. Pub. No. 2010/0081764 (Ouzineb et al.) disclose processes for making aqueous polymer dispersions. U.S. Pat. No. 10,221,343 (Qie et al.) discloses one-part, fast-setting, aqueous adhesive emulsions including a core-shell acrylic polymer.

### SUMMARY

Tackifiers are used in adhesives to improve adhesive performance. For waterborne adhesive systems, an adhesive emulsion is often blended with a tackifier dispersion. Due to the large particle size of the separate adhesive and tackifier particles, it is challenging for the adhesive and tackifier to mix well in very small scale and therefore achieve good adhesive performance under some challenging conditions.

Herein, a waterborne adhesive composition that has good performance on many different substrates is disclosed. In some embodiments, the composition can be defined as a hybrid composition, which has the adhesive polymer and tackifier in the same particle. Additionally, the acrylic polymer and tackifier are designed to be compatible. Typically and advantageously, upon polymerization, the tackifier is embedded within the polymeric particle which circumvents the need for a post-processing step to mix or compatibilize the separate adhesive and tackifier particles.

In one aspect the present disclosure provides a composition that includes an acrylic polymer having monomer units of at least one of an alkyl acrylate or alkyl methacrylate, in which alkyl has at least 8 carbon atoms, and at least 0.5 percent by weight of monomer units comprising a carboxylic acid, sulfonic acid, or phosphonic acid, based on the total weight of monomer units in the acrylic polymer, a first tackifier, an emulsifier, and water.

In some cases, if the first tackifier is an aromatic tackifier and has an aliphatic:aromatic hydrogen ratio or aliphatic:(unsaturated and aromatic) hydrogen ratio in a range from 75 to 80 as determined by proton nuclear magnetic resonance spectroscopy, the first tackifier is present in an amount of not more than 15.0 parts per 100 parts of the acrylic polymer. In some cases, if the first tackifier is an aromatic tackifier and has an aliphatic:aromatic hydrogen ratio or aliphatic:(unsaturated and aromatic) hydrogen ratio in a range from 75 to 80 as determined by proton nuclear magnetic resonance spectroscopy, the monomer units comprise at least 15 percent by weight of an alkyl acrylate or an alkyl methacrylate in which alkyl has at least 10 carbon atoms.

In some cases, alkyl has at least 10 carbon atoms, and the acrylic polymer further includes at least one of second monomer units of at least one of a C₄-C₉ alkyl acrylate or C₄-C₉ alkyl methacrylate or third monomer units of a high T_{g} monomer that when polymerized provides a homopolymer having a glass transition temperature of at least 20° C.

In some cases, the composition includes a second tackifier which differs from the first tackifier in at least one of molecular weight, aliphatic:aromatic hydrogen ratio or aliphatic:(unsaturated and aromatic) hydrogen ratio, softening point, or tackifier chemistry.

In some cases, the acrylic polymer includes third monomer units of a high T_{g} monomer that when polymerized provides a homopolymer having a glass transition temperature of at least 20° C., wherein the high T_{g} monomer has an alkyl group with at least four carbon atoms.

In some cases, the first tackifier is an aromatic hydrocarbon resin with at least one of a aliphatic:aromatic hydrogen ratio or aliphatic:(unsaturated and aromatic) hydrogen ratio of less than 50 or a molecular weight of at least 1200 grams per mole.

In another aspect, the present disclosure provides a process for making the composition. The process includes combining a tackifier and the at least one alkyl acrylate or alkyl methacrylate to form a solution, combining the solution with the water and the emulsifier, and polymerizing the at least one alkyl acrylate or alkyl methacrylate to form an emulsion with particles that include both the acrylic polymer and the tackifier.

In another aspect, the present disclosure provides a process for making a bonded article that includes a first substrate or a second substrate. The process includes applying the aforementioned composition on at least one of the first substrate or the second substrate and adhering the first substrate and the second substrate together.

In this application, terms such as “a”, “an” and “the” are not intended to refer to only a singular entity but include the general class of which a specific example may be used for illustration. The terms “a”, “an”, and “the” are used interchangeably with the term “at least one”. The phrases “at least one of” and “comprises at least one of” followed by a list refers to any one of the items in the list and any combination of two or more items in the list. All numerical ranges are inclusive of their endpoints and non-integral values between the endpoints unless otherwise stated (e.g., 1 to 5 includes 1, 1.5, 2, 2.75, 3, 3.8, 4, and 5, and the like).

The terms “first” and “second” are used in this disclosure in their relative sense only. It will be understood that, unless otherwise noted, those terms are used merely as a matter of convenience in the description of one or more of the embodiments.

As used herein, the term “acrylic” or “acrylate” includes compounds having at least one of acrylic or methacrylic groups.

The term “(meth)acrylate” with respect to a monomer, oligomer or polymer means a vinyl-functional alkyl ester formed as the reaction product of an alcohol with an acrylic or a methacrylic acid.

The term “(co)polymer” or “(co)polymeric” includes homopolymers and copolymers, as well as homopolymers or copolymers that may be formed in a miscible blend. The term “copolymer” includes random, block, graft, and star copolymers.

The term “crosslinking” refers to joining polymer chains together by covalent chemical bonds, usually via crosslinking molecules or groups, to form a network polymer. A crosslinked polymer is generally characterized by insolubility but may be swellable in the presence of an appropriate solvent.

“Alkyl group” and the prefix “alk-” are inclusive of both straight chain and branched chain groups and of cyclic groups. In some embodiments, alkyl groups have up to 30 carbons (in some embodiments, up to 25, 20, 18, 16, or 15 carbons) unless otherwise specified. Cyclic groups can be monocyclic or polycyclic. Alkyl groups are not fluorinated or perfluorinated.

The term “hydrocarbon” refers to compounds that have only carbon and hydrogen atoms.

The term “aromatic” with regard to the tackifier includes hydrogenated, partially hydrogenated, and non-hydrogenated aromatic.

PSAs are well known to those of ordinary skill in the art to possess properties including the following: (1) aggressive and permanent tack, (2) adherence with no more than finger pressure, (3) sufficient ability to hold onto an adherend, and typically, (4) sufficient cohesive strength to be cleanly removable from the adherend. PSAs are tacky and have the ability to adhere without activation by any energy source such as light, heat, or a chemical reaction. Materials that have been found to function well as PSAs are polymers designed and formulated to exhibit the requisite viscoelastic properties resulting in a desired balance of tack, peel adhesion, and shear holding power. One method useful for identifying pressure sensitive adhesives is the Dahlquist criterion. This criterion defines a pressure sensitive adhesive as an adhesive having a creep compliance of greater than 3×10⁻⁶ cm²/dyne as described in Handbook of Pressure Sensitive Adhesive Technology, Donatas Satas (Ed.), 2nd Edition, p. 172, Van Nostrand Reinhold, New York, NY, 1989. Alternatively, since modulus is, to a first approximation, the inverse of creep compliance, pressure sensitive adhesives may be defined as adhesives having a storage modulus of less than about 3×10⁵ N/m². The composition of the present disclosure can also be useful for making other adhesives, for example, with higher modulus.

The above summary of the present disclosure is not intended to describe each disclosed embodiment or every implementation of the present disclosure. The description that follows more particularly exemplifies illustrative embodiments. It is to be understood, therefore, that the following description are for illustration purposes only and should not be read in a manner that would unduly limit the scope of this disclosure.

### DETAILED DESCRIPTION

Acrylic polymers useful in the compositions and methods of the present disclosure include monomer units of at least one alkyl acrylate or alkyl methacrylate, in which alkyl has at least 8 carbon atoms. In some embodiments, alkyl has at least 10, 11, or 12 carbon atoms. Examples of suitable alkyl (meth)acrylates include those represented by Formula I:

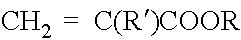

wherein R′ is hydrogen or a methyl group and R is an alkyl group having 8 to 30, 10 to 30, 12 to 30, 8 to 20, 10 to 20, 12 to 20, 10 to 18, 12 to 18, 10 to 16, or 12 to 16 carbon atoms and may be linear, branched, cyclic, or polycyclic. Examples of suitable monomers represented by Formula I include 2-ethylhexyl acrylate, n-octyl acrylate, 2-octyl acrylate, isooctyl acrylate, n-nonyl acrylate, isononyl acrylate, n-decyl acrylate, isodecyl acrylate, n-dodecyl acrylate, isomyristyl acrylate, n-tridecyl acrylate, n-tetradecyl acrylate, stearyl acrylate, isostearyl acrylate, isobornyl acrylate, octadecyl acrylate, behenyl acrylate, and methacrylates of the foregoing acrylates. Suitable monomer units further include mixtures of at least two or at least three structural isomers of a secondary alkyl (meth)acrylate of Formula II:

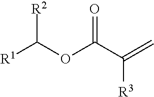

wherein R¹ and R² are each independently a C₁ to C₃₀ saturated linear alkyl group; the sum of the number of carbons in R¹ and R² is 7 to 31; and R³ is H or CH₃. The sum of the number of carbons in R¹ and R² can be, in some embodiments, 7 to 27, 7 to 25, 7 to 21, 7 to 17, 7 to 11, 7, 11 to 27, 11 to 25, 11 to 21, 11 to 17, or 11. Methods for making and using such monomers and monomer mixtures are described in U.S. Pat. No. 9,102,774 (Clapper et al.). In general, acrylates (as opposed to methacrylates) may be useful for providing PSA properties.

Mixtures of one or more monomers of Formula I, Formula II, or combinations of Formulas I and II may be useful for the acrylic polymer. In some embodiments, the acrylic polymer further comprises monomer units of a second monomer comprising at least one of a C₄-C₉ alkyl acrylate or C₄-C₉ alkyl methacrylate, in some embodiments, a C₄-C₉ alkyl acrylate. Suitable C₄-C₉ alkyl (meth)acrylates include n-butyl methacrylate, iso-butyl acrylate, t-butyl acrylate, hexyl acrylate, cyclohexylacrylate, norbomyl acrylate, heptyl acrylate, 2-ethylhexyl acrylate, n-octyl acrylate, 2-octyl acrylate, isooctyl acrylate, n-nonyl acrylate, isononyl acrylate, isobornyl acrylate, methacrylates of the foregoing acrylates, and combinations thereof. In some embodiments, the second monomer is a C₆-C₉ alkyl (meth)acrylate or a C₆-C₈ alkyl (meth)acrylate. In some embodiments in which the acrylic polymer includes monomer units of a second monomer, at least one of the alkyl acrylate or alkyl methacrylate (e.g., of Formula I or II) has at least 10, 11, or 12 carbon atoms.

The acrylic polymer useful in the compositions and methods of the present disclosure include a carboxylic acid, sulfonic acid, or phosphonic acid. Monomers that have carboxylic acid, sulfonic acid, or phosphonic acid groups include acrylic acid, methacrylic acid, itaconic acid, maleic acid, fumaric acid, ethacrylic acid, crotonic acid, citraconic acid, cinnamic acid, beta-carboxy ethyl acrylate, 2-methacrylolyloxyethyl succinate, 2-acrylamido-2-methylpropane sulfonic acid, vinyl phosphonic acid, and combinations thereof. Monomers units including a carboxylic acid, sulfonic acid, or phosphonic acid encompasses salts of these acids, such as alkali metal salts and ammonium salts. In some embodiments, at least 0.5, 1, 1.5, 2, 3 or 4 percent by weight of monomer units in the acrylic polymer useful in the compositions and methods of the present disclosure include a carboxylic acid, sulfonic acid, or phosphonic acid. In some embodiments, these monomer units are included in the acrylic polymer in an amount up to 10, 8, 6, 5 or 4 percent by weight, based on the total weight of monomer units in the acrylic polymer. In some embodiments, these monomer units include a carboxylic acid group. The different acids can be used alone or combined. For example, high T_{g} acids/low T_{g} acids (i.e., methacrylic acid/2-carboxy ethyl acrylate) can be used together to enhance adhesive cohesive strength, while keep good adhesion, especially at high peel rate. For some conditions, using a more hydrophobic acid (methacrylic acid) can result in cleaner emulsion.

In some embodiments, the acrylic polymer further comprises monomer units of a “high T_{g}” monomer that when homopolymerized provides a homopolymer having a glass transition temperature (T_{g}) of at least 20° C., at least 40° C., or at least 50° C. (i.e., a homopolymer formed from the monomer has a T_{g} at least 20° C., at least 40° C., or at least 50° C.). The T_{g} of the homopolymers are measured by Differential Scanning Calorimetry, and many are reported in the Polymer Properties Database found at polymerdatabase.com. Some suitable high T_{g} monomers have a single (meth)acryloyl group such as methyl methacrylate, ethyl methacrylate, n-propyl methacrylate, isopropyl methacrylate, n-butyl methacrylate, isobutyl methacrylate, sec-butyl methacrylate, tert-butyl (meth)acrylate, cyclohexyl methacrylate, isobornyl (meth)acrylate, stearyl (meth)acrylate, phenyl acrylate, benzyl methacrylate, 3,3,5 trimethylcyclohexyl (meth)acrylate, tert-butyl cyclohexyl (meth)acrylate, cyclic trimethylolpropane formal acrylate, dicyclopentanyl (meth)acrylate, 2-phenoxyethyl methacrylate, N-octyl (meth)acrylamide, tetrahydrofurfuryl methacrylate, and mixtures thereof. Other suitable high T_{g} monomers have a single vinyl group that is not a (meth)acryloyl group such as various vinyl ethers (e.g., vinyl methyl ether), vinyl esters (e.g., vinyl acetate and vinyl propionate), styrene, substituted styrene (e.g., α-methyl styrene), vinyl halide, and mixtures thereof. In some embodiments, the high T_{g} monomer has an alkyl group with at least 4, 5, or 6 carbon atoms. In these embodiments, methyl methacrylate, ethyl methacrylate, n-propyl methacrylate, and isopropyl methacrylate can be excluded.

In some embodiments, the acrylic polymer further comprises monomer units of a polar monomer including at least one ketone, amide, amine, alcohol or combination thereof. Examples of polar monomers with a hydroxyl group include hydroxyalkyl (meth)acrylates (e.g., 2-hydroxyethyl (meth)acrylate, 2-hydroxypropyl (meth)acrylate, 3-hydroxypropyl (meth)acrylate, and 4-hydroxybutyl (meth)acrylate), hydroxyalkyl (meth)acrylamides (e.g., 2-hydroxyethyl (meth)acrylamide or 3-hydroxypropyl (meth)acrylamide), ethoxylated hydroxyethyl (meth)acrylate (e.g., monomers commercially available from Sartomer (Exton, PA, USA) under the trade designation CD570, CD571, and CD572), and aryloxy substituted hydroxyalkyl (meth)acrylates (e.g., 2-hydroxy-2-phenoxypropyl (meth)acrylate). Examples of polar monomers with a primary amido group include (meth)acrylamide. Examples of polar monomers with secondary amido groups include N-alkyl (meth)acrylamides such as N-methyl (meth)acrylamide, N-ethyl (meth)acrylamide, N-isopropyl (meth)acrylamide, N-tert-octyl (meth)acrylamide, and N-octyl (meth)acrylamide. Examples of polar monomers with a tertiary amido group include N-vinyl caprolactam, N-vinyl-2-pyrrolidone, (meth)acryloyl morpholine, and N,N-dialkyl (meth)acrylamides such as N,N-dimethyl (meth)acrylamide, N,N-diethyl (meth)acrylamide, N,N-dipropyl (meth)acrylamide, and N,N-dibutyl (meth)acrylamide. Polar monomers with an amino group include various N,N-dialkylaminoalkyl (meth)acrylates and N,N-dialkylaminoalkyl (meth)acrylamides. Examples include N,N-dimethyl aminoethyl (meth)acrylate, N,N-dimethylaminoethyl (meth)acrylamide, N,N-dimethylaminopropyl (meth)acrylate, N,N-dimethylaminopropyl (meth)acrylamide, N,N-diethylaminoethyl (meth)acrylate, N,N-diethylaminoethyl (meth)acrylamide, N,N-diethylaminopropyl (meth)acrylate, and N,N-diethylaminopropyl (meth)acrylamide. Examples of polar monomers that include ketones include diacetone acrylamide and acetoacetoxy ethyl methacrylate. In some embodiments, not more than 5, 4, 3, 2, 1, 0.5, 0.25, 0.1, 0.05, or 0.01 percent by weight of monomer units in the acrylic polymer useful in the compositions and methods of the present disclosure include at least one ketone, amide, amine, alcohol, or combination thereof. The acrylic polymer may be free of polar monomer units.

Crosslinked acrylic PSAs may be made, for example, by using one or more polyfunctional crosslinking monomers. In some embodiments, the acrylic polymer further comprises monomer units of a multifunctional acrylate or multifunctional methacrylate. Suitable polyfunctional monomers include diacrylate esters of diols, such as ethylene glycol diacrylate, diethylene glycol diacrylate, propanediol diacrylate, butanediol diacrylate, butane-1,3-diyl diacrylate, pentanediol diacrylate, hexanediol diacrylate (including 1,6-hexanediol diacrylate), heptanediol diacrylate, octanediol diacrylate, nonanediol diacrylate, decanediol diacrylate, and dimethacrylates of any of the foregoing diacrylates. Further suitable polyfunctional monomers include polyacrylate esters of polyols, such as glycerol triacrylate, dipropylene glycol diacrylate, tripropylene glycol diacrylate, trimethylolpropane triacrylate, pentaerythritol tetraacrylate, neopentyl glycol diacrylate, dipentaerythritol pentaacrylate, methacrylates of the foregoing acrylates, and combinations thereof. Further suitable polyfunctional crosslinking monomers include divinyl benzene, allyl methacrylate, diallyl maleate, diallyl phthalate, and combinations thereof. Further suitable polyfunctional crosslinking monomers include polyfunctional acrylate oligomers comprising two or more acrylate groups. The polyfunctional acrylate oligomer may be a urethane acrylate oligomer, an epoxy acrylate oligomer, a polyester acrylate, a polyether acrylate, a polyacrylic acrylate, a methacrylate of any of the foregoing acrylates, or a combination thereof. Combinations of any of these crosslinking monomers may be useful. In some embodiments, not more than 1, 0.5, 0.25, 0.1, 0.05, or 0.01 percent by weight of monomer units in the acrylic polymer useful in the compositions and methods of the present disclosure are derived from crosslinking monomers. The acrylic polymer may be free of crosslinking monomer units.

In some embodiments, the acrylic polymer can contain up to 99.5 weight percent of monomer units of at least one alkyl acrylate or alkyl methacrylate, in which alkyl has at least 8 carbon atoms as described above in any of its embodiments. The weight percent value is based on the total weight of monomeric units in the acrylic polymer. In some embodiments, the acrylic polymer contains 65 to 99.5 weight percent of monomer units of at least one alkyl acrylate or alkyl methacrylate, in which alkyl has at least 8 carbon atoms as described above in any of its embodiments, 0.5 to 5 weight percent of acid functional monomer units as described above in any of their embodiments, 0 to 5 weight percent polar monomeric units, 0 to 70 or 0 to 40 weight percent high T_{g} monomeric units, and 0 to 5 weight percent crosslinking monomeric units. In some embodiments, the acrylic polymer contains 80 to less than 99 weight percent of monomer units at least one alkyl acrylate or alkyl methacrylate, in which alkyl has at least 8 carbon atoms as described above in any of its embodiments, greater than 1 to 5 weight percent of acid functional monomer units as described above in any of their embodiments, 0 to 5 weight percent polar monomeric units, 0 to 20 weight percent high T_{g} monomeric units, and 0 to 1 weight percent crosslinking monomer units. In some embodiments, the acrylic polymer contains 80 to 98.5 weight percent of monomer units at least one alkyl acrylate or alkyl methacrylate, in which alkyl has at least 8 carbon atoms as described above in any of its embodiments, 1.5 or 2 to 5 weight percent of acid functional monomer units as described above in any of their embodiments, 0 to 1 weight percent polar monomeric units, 0 to 20 weight percent high T_{g} monomeric units, and 0 to 0.5 weight percent crosslinking monomer units. In some embodiments, the monomer units comprise at least 15, 20, 25, 30, 40, or 50 percent by weight of an alkyl acrylate or an alkyl methacrylate in which alkyl has at least 10 carbon atoms.

In some embodiments, the acrylic polymer in the emulsion of the acrylic polymer in water is not a core-shell polymer having different monomer compositions in the core and the shell. While polymerizations result in a distribution of compositions and molecular weights, the emulsion polymerization is, in some embodiments, not carried out so that the monomer composition is changed during the polymerization to provide polymer particles with cores having a different glass transition temperature or a different reactivity from the shell.

Depending on the amount of any of the tackifiers and other additives described below, in some embodiments, the composition may include at least 60, 70, 75, 80, 90, 95, 98, 99, or 99.5 weight percent of the acrylic polymer described above in any of its embodiments, based on the total amount of solids in the composition (that is, excluding water).

The composition of the present disclosure and useful for practicing the present disclosure further comprises a tackifier. In some embodiments, the tackifier comprises at least one of rosin, a rosin derivative a rosin ester, an ester of hydrogenated rosin, a terpene resin such as a polyterpene (e.g., those based on α-pinene, β-pinene, or limonene), a hydrogenated polyterpene, a modified polyterpene (e.g., an aromatically modified polyterpene or phenol modified polyterpene), an aliphatic hydrocarbon resin (e.g., those based on cis- or trans-piperylene, isoprene, 2-methyl-but-2-ene, cyclopentadiene, dicyclopentadiene, or combinations thereof), an aromatic resin (e.g. those based on styrene, α-methyl styrene, vinyl toluene, vinyl xylene, propenyl benzene, methyl indene, indene, ethyl indene, coumarone, or combinations thereof), or a mixed aliphatic-aromatic hydrocarbon resin. The aromatic hydrocarbon resins may be C9-type petroleum resins obtained by copolymerizing a C9 fraction or mixed C9 feedstocks (e.g., those based on styrene, α-methyl styrene, vinyl toluene, vinyl xylene, propenyl benzene, methyl indene, indene, ethyl indene, or combinations thereof) produced by thermal decomposition of petroleum naphtha, and aliphatic hydrocarbon resins may be C5-type petroleum resins obtained by copolymerizing a C5 fraction produced by thermal decomposition of petroleum naphtha. Aromatic hydrocarbon resins may also be synthesized from pure monomers (e.g., styrene, α-methyl styrene, vinyl toluene, vinyl xylene, propenyl benzene, methyl indene, indene, ethyl indene, or combinations thereof). Mixed aliphatic/aromatic resins may be C5/C9-type petroleum resins obtained by polymerizing a combination of a C5 fraction and a C9 fraction or mixed C9 feedstocks produced by thermal decomposition of petroleum naphtha. Any of these tackifying resins may be hydrogenated (e.g., partially, or completely). The term rosin, as employed herein, includes natural rosin, refined or unrefined (refined rosin will usually contain, by weight, about 90% of rosin acids and about 10% of inert material), such as natural wood rosin, natural gum rosin, and tall oil rosin; modified rosin, refined or unrefined, such as disproportionated rosin, hydrogenated rosin, and polymerized rosin; and the pure or substantially pure acids, of which rosin is comprised, alone or in admixture. In some embodiments, the tackifier is a hydrocarbon tackifier. In some embodiments, useful tackifiers can have a number average molecular weight of up to 10,000 grams per mole, a softening point of at least 30° C. or in a range from 85° C. to 160° C. as determined using a ring and ball apparatus (generally according to ASTM E 28), and a glass transition temperature of at least −30° C. as measured by differential scanning calorimetry. Useful tackifiers are typically amorphous. In some embodiments, the tackifier is miscible with the acrylic polymer of the composition such that macroscopic phase separation does not occur in the composition. In some embodiments, at least one tackifier can be liquid.

In some embodiments, a combination of tackifiers (e.g., differing in at least one of molecular weight, hydrogenation degree, aliphatic:aromatic hydrogen ratio or aliphatic:(unsaturated and aromatic) hydrogen ratio, softening point, or tackifier chemistry) may be useful to obtain a good balance of compatibility and adhesive performance (e.g., high temperature performance). For example, fully hydrogenated aromatic hydrocarbon tackifiers do not significantly affect polymerization, but when a large amount is used, especially those with very high softening point, it can result in incompatibility with the adhesive polymer, if the polymer composition does not include the compositions as presently claimed). In contrast, rosin ester based tackifiers, terpene based tackifiers, aromatically modified terpene tackifiers, phenol modified tackifiers, and partially hydrogenated aromatic hydrocarbon tackifiers are in general more compatible with (meth)acrylic polymer. Therefore, the fully hydrogenated C9 tackifier can be used with other more compatible tackifiers. The purity of the terpene and rosin tackifiers may affect polymerization, even hydrogenated terpene and rosin tackifiers; therefore, it may be useful to limit the amount of terpene and rosin tackifiers. Other examples include using tackifiers with different softening points and/or levels of hydrogenation.

Examples of suitable tackifiers include those obtained under the trade designations “FORAL 85E” (a glycerol ester of highly hydrogenated refined gum rosin) commercially available from Eastman, Middelburg, NL, “FORAL 3085” (a glycerol ester of highly hydrogenated refined wood rosin) commercially available from Pinova, Brunswick, GA; rosin ester tackifiers from Arakawa (e.g., “PENSEL” GA-85H, GA-90, GA-100, GB-120, D-125, D-135, or D-160); polyterpene tackifiers (e.g., Sylvares 3125 from Kraton), aromatically modified polyterpene (e.g., TO125, TO115, or T0105 from Yasuhara), phenol modified terpene (e.g., U130, T130, TH130, or TH160 from Yasuhara); and “ESCOREZ 2520” and “ESCOREZ 5615” (aliphatic/aromatic hydrocarbon resins) commercially available from ExxonMobil Corp., Houston, TX.

Further examples of suitable tackifiers include partially hydrogenated aromatic resins such as those obtained under the trade designation “REGALITE” or “REGALREZ” from Synthomer, Kingsport, Tennessee (e.g., REGALITE R7100, REGALITE S7125, REGALITE S1090, REGALITE S5100, REGALREZ 3102 and REGALREZ 6108) and the M series or those obtained under the trade designation “ARKON” from Arakawa (e.g., M100, M115, M135). Suitable fully hydrogenated aromatic resin tackifiers include those obtained under the trade designation “REGALITE” or “REGALREZ” from Synthomer (e.g., REGALITE R1010, REGALITE R1090, REGALITE R1100, REGALITE S1100, REGALITE R1125, REGALREZ 1126, REGALREZ 1094, and PLASTOLYN R1140) and the P series hydrocarbon tackifier obtained under the trade designation “ARKON” from Arakawa (e.g., P100, P115, P125, P140).

In general, the higher the hydrogenation degree of these aromatic hydrocarbon resin tackifiers or the higher the purity of the monomers used to make these aromatic resins, the lower the negative effect they have on polymerization. It was unexpectedly discovered that the compatibility of these aromatic hydrocarbon tackifiers with some acrylic polymers depends on their softening point and/or hydrogenation degree, which can be correlated to the aliphatic/aromatic ratio or aliphatic/(aromatic & unsaturated) ratio as determined by proton nuclear magnetic resonance spectroscopy (¹H NMR) using the method in the Examples below.

In some embodiments in which the tackifier includes an aromatic hydrocarbon resin, when the aromatic hydrocarbon tackifier is fully hydrogenated and has an aliphatic/aromatic ratio or aliphatic/(aromatic & unsaturated) ratio of about 34, 35, 40 or above, some tackifiers, especially those with higher softening point (e.g., typically >about 125° C.) are less compatible with the acrylic polymer, and consequently, adhesive materials may not be readily prepared with conventional monomers. In contrast, we found partially hydrogenated tackifiers (e.g., ratios around 3 to 30, 4 to 25, 5 to 20, or 9 to 16) are more compatible with some acrylic polymers. For acrylic polymer compatible tackifiers, a higher softening point or molecular weight can provide a better PSA performance (e.g., higher peel and/or shear). In some embodiments, the molecular weight is a least 1200 grams per mole as determined using the method in the examples below. In some embodiments, the first tackifier has a softening point in a range from 115° C. to 160° C. or 115° C. to 140° C. In some embodiments, a combination oftackifiers with different molecular weights, softening points, chemistry (e.g., a rosin ester or terpene in combination with an aromatic hydrocarbon tackifier), and/or different levels of hydrogenation is useful for adhesive performance and compatibility. In some embodiments, acrylic polymers including certain monomers (as presently claimed) can improve compatibility with a range of tackifiers, as described in further detail below.

In some embodiments, the tackifier is present in the composition in a range from 0.5, one, or two parts to 50, 40, or 30 parts by weight per one hundred parts of acrylic polymer. In some embodiments, the tackifier is present in a range from 0.5, 1, 2 to 40, 2 to 35, 5 to 30, 7 to 25, 8 to 20, 2 to 25, 2 to 20, 5 to 25, 10 to 25, 10 to 20, 2 to 15, or 2 to 10 parts by weight per one hundred parts of the acrylic polymer.

The acrylic polymer useful in the compositions and methods of the present disclosure is conveniently prepared by emulsion polymerization. An acrylic monomer or combination of monomers as described above in any of their embodiments is combined with water and an emulsifier or combination of emulsifiers and then the monomer or monomers are polymerized. One or more of the monomers can be emulsified first in the stirred aqueous phase before initiation is begun. In some embodiments, the method of the present disclosure provides combining a tackifier and at least one alkyl acrylate or alkyl methacrylate, each as described above in any of their embodiments, to form a solution, combining the solution with the water and the emulsifier, and polymerizing the at least one alkyl acrylate or alkyl methacrylate in the presence of the tackifier. The many parameters of emulsion polymerization technique can be adjusted by those skilled in the art. For example, initiator can be added according to a variety of possible schedules, and monomers can be added continuously or in staggered increments. Additionally, a polymerization can be started in the presence of a previously prepared seed.

The emulsifier used in the emulsion polymerization is typically present in the composition of the present disclosure. In some embodiments, the emulsifier used in the emulsion polymerization is an anionic surfactant. Useful anionic surfactants include those that include at least one hydrophobic moiety such as an about 6 carbon atom- to about 12 carbon atom-alkyl, alkylaryl, and/or alkenyl group as well as at least one anionic group selected from carboxylate, sulfate, sulfonate, phosphate, polyoxyethylene sulfate, polyoxyethylene sulfonate, polyoxyethylene phosphate, and/or salts of such anionic groups such as alkali metal salts (e.g., sodium, potassium) and ammonium salts. Any fatty acid soap (e.g., alkyl succinates), ethoxylated fatty acids, and/or the alkali metal salts ammonium salts thereof, dialkylsulfosuccinates, and sulfated oils may be useful. Some useful anionic surfactants include sodium lauryl sulfate, sodium lauryl ether sulfate, sodium dodecylbenzene sulfonate and sulfosuccinate esters. Representative commercial examples of anionic surfactants include sodium lauryl sulfate, available from Stepan Chemical Co. under the trade designation “POLYSTEP B-3”; sodium lauryl ether sulfate, available from Stepan Chemical Co. under the trade designation “POLYSTEP B-12”; and sodium dodecylbenzenesulfonate, available from Rhodia, Incorporated under the trade designation “RHODACAL DS-10”. Combinations of any of these surfactants may be useful.

In some embodiments, the emulsifier is copolymerizable with the monomer or monomer mixture and becomes incorporated into the acrylic polymer. The copolymerizable emulsifier has at least one group, or only one group, capable of reacting with the monomer or monomer mixture. Such reactive groups include ethylenically unsaturated groups such as vinyl groups and acrylate groups. Examples of polymerizable emulsifiers include sodium styrene sulfonate (commercially available from Alfa Aesar), sodium vinylsulfonate, polysodium styrene sulfonate, polyoxyethylene alkylphenyl ether ammonium sulfates those obtained under the trade designation “HITENOL BC” from Montello, Inc., Kyoto, Japan, including polyoxyethylene nonylpropenyl phenyl ether ammonium sulfate, polyoxyethylene styrenated phenyl ether ammonium sulfates such as those obtained under the trade designation “HITENOL AR” from Montello, Inc., and polyoxyethylene alkylether sulfuric esters such as those obtained under the trade designation “HITENOL KH” from Montello, Inc. A copolymerizable surfactant can result in improved emulsion stability, or/and improve adhesive performance.

The total amount of surfactant used in the preparation of the emulsion is typically 5 parts or less, 3 parts or less, 2 parts or less, 1.75 parts or less, 1.5 parts or less, or 1.3 parts or less or 0.7 parts or less by weight per 100 parts by weight of the total monomers. In some embodiments, the total amount of emulsifier employed is anionic in nature.

In some embodiments a small amount (e.g., less than 5 wt. % of the total surfactant amount) of nonionic surfactant may be employed if desired. Such surfactants are well known to those skilled in the art. Representative commercial examples of nonionic surfactants include the “TRITON X” series of surfactants (octylphenol ethoxylates), “TRITON CG 600” (a polyalkyl glucoside) available from Dow Chemical Company, and polymerizable surfactants including polyoxyethylene alkylphenyl ethers such as those obtained under the trade designation “NOIGEN RN” from Montello, Inc.

Emulsion polymerization, mini-emulsion polymerization, mini-suspension, and suspension polymerization could be used to make the waterborne hybrid adhesive comprising tackifier. For suspension polymerizations, oil-soluble initiators can be used. When mini-emulsion or mini-suspension polymerization is used, high shear mixing equipment will be needed to produce particles (e.g., from ~50 nm to 20 micron). For these two polymerization methods, oil soluble can be used. When the particle size is small enough (e.g., <5 micron, or <2 micron, or <1 micron), water-soluble initiators can also be used. Using combination of oil and water-soluble initiator has not been reported before according to our knowledge. We found it has some advantages such as good monomer conversion and good performance.

Emulsion polymerization, mini-emulsion polymerization, mini-suspension, and suspension polymerization is carried out in water. The water is present in the composition of the present disclosure. The amount of water in the composition is typically at least 25% by weight or 30% by weight, based on the total weight of the composition. The amount of water in the composition can be up to 55%, 50%, 45%, or 40% by weight, based on the total weight of the composition. Useful amount of water in the compositions can be in a range from 25% to 55% by weight, 25% to 50% by weight, or 30% to 40% by weight, based on the total weight of the composition.

Polymerizing the at least one alkyl acrylate or alkyl methacrylate to form acrylic polymer typically involves a polymerization initiator. Polymerization initiators useful in preparing the acrylate polymers used in the present disclosure include initiators that, on exposure to heat, generate free-radicals, which initiate polymerization of the monomer or monomer mixture. Water-soluble initiators are useful for preparing the acrylate polymers by emulsion polymerization, mini-emulsion polymerization, mini-suspension, and suspension polymerization. Suitable water-soluble initiators include potassium persulfate, ammonium persulfate, sodium persulfate, and mixtures thereof, oxidation-reduction initiators such as the reaction product of the above-mentioned persulfates and reducing agents such as those selected from the group metabisulfites, formaldehyde sulfoxylate, 4,4′-azobis(4-cyanopentanoic acid) and its soluble salts (e.g., sodium, potassium), and advanced sulfinic acid derivatives such as those obtained under the trade designations “BRUGGOLITE FF6 M” and “BRUGGOLITE TP1651” from L.

Brueggemann GMBH & Co. KG., Heilbronn, Germany. When used, initiators may comprise from about 0.01 to about 1 part by weight, 0.05 to about 1 part by weight, or about 0.1 to about 0.5 part by weight based on 100 parts by weight of monomer or monomer. A final oxidation/reducing initiator pair can be added at the end of the reaction to increase conversion. In some embodiments, the polymerization initiator is a water-soluble initiator (e.g., a water-soluble free-radical initiator) or a water-soluble initiator combination including an oxidizing agent and reducing agent. In some embodiments, the polymerization initiator is an oil-soluble initiator.

Oil soluble initiators such as those obtained under the trade designation “VAZO” from Chemours, Wilmington, DE (e.g., VAZO 52, VAZO 64, VAZO 88), and benzoylperoxide can also be used for the (mini-emulsion or suspension) polymerization. Water soluble initiators can also be used together with oil soluble initiators for the polymerization in a mini-emulsion or a mini-suspension. In the mini-emulsion or mini-suspension polymerization (<10 micrometer), the combination of oil and water-soluble initiators is advantageous for achieving good conversion and also further tuning the adhesive performance.

### Photoinitiators May Also be Useful

Catalysts may be useful to accelerate free radical generation. Examples of suitable catalysts include ferrous sulfate and ethylene diamine tetra-acetic acid (EDTA).

Mixtures including the acrylic monomer or combination of monomers as described above in any of their embodiments, water, and an emulsifier may optionally further comprise chain transfer agents to control the molecular weight of the acrylic polymer. Examples of useful chain transfer agents include carbon tetrabromide, alcohols, mercaptans such as, for example, isooctyl thioglycolate, 2-ethylhexyl thioglycolate, and mixtures thereof.

Emulsion polymerization can be carried out at a wide variety of temperatures. The temperature can be selected readily by a person skilled in the art and can depend at least in part on the initiator used. In some embodiments, the polymerization is carried out at a temperature in a range from 10° C. to 100° C., in a range from 30° C. to 90° C., or in a range from 40° C. to 80° C.

In addition to the acrylic monomer or combination of monomers as described above in any of their embodiments, water, emulsifier, initiator, and optionally the catalyst and chain transfer agent, the following additives may also optionally be included in the emulsion compositions useful for practicing the present disclosure: inhibitors such as hydroquinone, pigments, dyes, rheology modifiers, thickeners, tackifiers, plasticizers, antioxidants (e.g., hindered phenols, amines, and sulfur and phosphorous hydroperoxide decomposers), stabilizers (e.g., ultraviolet absorbers, hindered amine light stabilizers, and heat stabilizers), fillers (e.g., inorganic fillers such as talc, zinc oxide, titanium dioxide, aluminum oxide), preservatives, biocides, corrosion inhibitors, fire retardants, and defoamers. These additives, if used, are present in conventional concentrations well known to those skilled in the art and to the extent they do not unacceptably affect the advantages provided by the present disclosure. After polymerization, an external crosslinker can also be used to crosslink the adhesive polymer. For example, adipic acid dihydrazide, which can react with the COOH group or diacetone acrylamide, for example, can be added after polymerization.

In some embodiments of the process for making the composition of the present disclosure, the process comprises, combining the tackifier and the at least one alkyl acrylate or alkyl methacrylate to form a solution, combining the solution with the water and the emulsifier, and polymerizing the at least one alkyl acrylate or alkyl methacrylate to form an emulsion with droplets that include both the acrylic polymer and the tackifier. The solution can include any of the other optional monomers described above. Polymerizing the monomer or monomer mixture in the presence of the tackifier can lead to good mixing of the tackifier and acrylic polymer, which can help improve adhesive performance.

Acrylic polymers including monomer units of at least one alkyl acrylate or alkyl methacrylate, in which alkyl has at least 8, 10, 11, or 12 carbon atoms, in some embodiments, at least 10, 11, or 12 carbons, tend to be more compatible with some tackifiers, in some embodiments, hydrocarbon tackifiers, in some embodiments, fully hydrogenated hydrocarbon tackifiers. High incompatibility of the acrylic polymer and tackifier, if present, can lead to coagulation during (mini-)emulsion or (mini-)suspension polymerization of the acrylic polymer. Such an emulsion or suspension would not be stable under storage or use conditions and would not provide good adhesive performance. Haziness observed in an adhesive can also be the result of incompatibility. In some embodiments, an alkyl methacrylate having at least 10, 11, or 12 carbons and/or a high Tg monomer as described above can be useful to improve compatibility with some tackifiers. If an alkyl acrylate or alkyl methacrylate having at least 10, 11, or 12 carbons is present, high Tg monomers having an alkyl group with at least 5 carbon atoms or less than 5 carbon atoms can be useful. In some embodiments, the high Tg monomer comprises at least one of isobornyl (meth)acrylate, 3,3,5 trimethylcyclohexyl (meth)acrylate, tert-butyl cyclohexyl (meth)acrylate, or dicyclopentanyl (meth)acrylate.

A high Tg monomer with a ring structure (e.g., isobornyl (meth)acrylate (IBO(M)A), trimethylcyclohexyl (meth)acrylate, tert-butyl cyclohexyl (meth)acrylate, or dicyclopentanyl (meth)acrylate) can improve an adhesive's glass transition temperature. It can also improve adhesive's bonding performance on non-polar substrate. Additionally, there are advantages of using these high Tg monomers with a ring structure with other high Tg monomers (e.g., C4 (meth)acrylate) with regard to overall cost and/or odor. For example, useful combinations include IBOA/CHMA (cyclohexyl methacrylate), IBOA/TBMA (tert-butyl methacrylate), IBOA/IBMA (iso-butyl methacrylate), and IBOMA/IBOA.

In view of the above, in some embodiments, we have found that the following strategies are unexpectedly useful. If the tackifier is a fully hydrogenated aromatic hydrocarbon tackifier, which has the aliphatic/aromatic ratio around 35 or above, limiting the amount of tackifier may be useful. If the tackifier is a fully hydrogenated aromatic hydrocarbon tackifier, which has the aliphatic/aromatic ratio around 35 or above, high Tg monomers and/or alkyl acrylates having alkyl groups with 10 or more carbon atoms can be used to design polymers that compatible with these tackifiers (e.g., IBOA, IBOMA, TBCHA, TBCHMA, or DAIB). If the tackifier is a fully hydrogenated aromatic hydrocarbon tackifier, which has the aliphatic/aromatic ratio around 35 or above, using a partially hydrogenated resin, which has aliphatic/aromatic ratio less than 50, from about 2 to 34, or 3 to 30, in combination may be useful. We have found that these partially hydrogenated resins are more compatible with acrylic polymers. Accordingly, an aromatic hydrocarbon resin with an aliphatic:aromatic hydrogen ratio or aliphatic:(unsaturated and aromatic) hydrogen ratio of less than 50 (e.g., 2 to 34 or 3 to 30) is useful as a tackifier on its own. A higher softening point tackifier can be useful to improve adhesive performance. Some of these higher softening points might not be so compatible with (some) monomer, so we can introduce some special monomers to improve the tackifier/polymer compatibility. For example, high Tg monomers can be useful to improve adhesive polymer's glass transition temperature and therefore to improve adhesive performance (e.g., isobornyl acrylate, tert-butyl methacrylate). Among the high Tg monomers, monomers with (non-polar) ring structure (e.g., IBOA, IBOMA) usually result in better performance especially on some substrate (e.g., low surface energy). Additionally, some monomers with special ring structure (e.g, IBOA) perform better than others (cyclohexyl methacrylate). Certain combinations can be particularly useful to achieve good performance (e.g., IBOA/cyclohexyl methacrylate, or IBOA/tert-butyl methacrylate, or DAIB/IBOA/cyclohexyl methacrylate, etc).

The waterborne adhesive as described above in any of its embodiments, including embodiments in which the adhesive comprises particles includes both the acrylic polymer and the tackifier, includes droplets having a size in a range from 30 nanometers (nm) to 100 micrometers, from 50 nm to 10 micrometers, from 200 nm to 500 nm to 2 micrometers, from 200 nm to 600 nm, 50 nm to 50 micrometers, from 50 nm to 5 micrometers, or from 200 nm to 500 nm as determined by dynamic light scattering measurements, which is a technique well-known to a person skilled in the art of emulsion polymerization. In some embodiments, the droplet size is 700 nm, 600 nm, or 500 nm or less, 400 nm or less, or 300 nm or less. In some embodiments, the particle size is at least 50 nm, at least 100 nm, or at least 130 nm.

Upon completion of the polymerization, the waterborne adhesive useful in the compositions and methods of the present disclosure is typically acidic as determined using a standard pH meter or pH paper as is known to those skilled in the art. In some embodiments, the pH of the emulsion is about 3. In some embodiments of the or composition of the present disclosure, the composition further comprises base, for example, to raise the pH. In some embodiments, the pH is raised to at least 3.5, 4, 5, 6, 7, 8, or 9. Examples of suitable bases include ammonia (e.g., aqueous ammonia or ammonium hydroxide), ethanolamine, sodium hydroxide, triethylamine, and sodium carbonate. In some embodiments, the pH is of the emulsion is in a range from 3 to 5, 3 to 6, 3 to 7, 7 to 10, 7.5 to 10, or 7 to 9.5.

In some embodiments, the waterborne adhesive useful for the composition or methods of the present disclosure exhibit a viscosity of 12,000 centipoise (12,000 mPa-s) or less as determined using a Brookfield Viscometer, spindle 6, at 20 rpm. In some embodiments, the viscosity of the emulsion is not more than 10,000 centipoise (10,000 mPa-s), 7500 centipoise (75000 mPa-s), 5000 centipoise (5000 mPa-s), 3000 centipoise (3000 mPa-s), or 1000 centipoise (1000 mPa-s). In some embodiments, the emulsions have a viscosity of at least 300 centipoise (300 m Pa-s) or at least 500 centipoise (500 m Pa-s).

In some embodiments, the composition of the present disclosure and/or made by the method disclosed herein is substantially free of organic solvents. Common organic solvents include any of those have a boiling point of up to 150° C. at atmospheric pressure. The term “substantially free” means that composition can include up to 0.5, 0.1, 0.05, or 0.01 percent by weight of any of these solvents or can be free of any of these solvents. These percentages are based on the total weight of the composition.

In some embodiments, the waterborne adhesive can be blended with a tackifier dispersion after the polymerization of the monomers.

In some embodiments of the composition according to the present disclosure and/or method of making or using the composition of the present disclosure, the composition is substantially free of thermoplastic microspheres containing a blowing agent. Thermoplastics for the microspheres may refer to thermoplastics obtainable by polymerizing ethylenically unsaturated monomers such as (meth)acrylates (e.g., methyl acrylate, ethyl acrylate, methyl methacrylate, isobornyl methacrylate, or ethyl methacrylate; monomers comprising nitrile groups (e.g., acrylonitrile, methacrylonitrile, alpha-chloroacrylonitrile, alpha-ethoxyacrylonitrile, fumaronitrile, or crotonitrile); vinyl halides (e.g., vinyl chloride); vinyl esters (e.g., vinyl acetate); vinylpyridine; vinylidene halides (e.g., vinylidene chloride); styrenes (e.g., styrene, halogenated styrenes, or alpha-methylstyrene); dienes (e.g., butadiene, isoprene, or chloroprene); and vinyl ethers (e.g., alkyl vinyl ethers having from one to ten carbon atoms). Blowing agents for the microspheres may refer to a liquid having a boiling point not higher than the softening temperature of the thermoplastic polymer shell, and may comprise hydrocarbons (e.g., propane, n-pentane, isopentane, neopentane, butane, isobutane, hexane, isohexane, neohexane, heptane, isoheptane, octane, isooctane, and mixtures thereof, and petroleum ethers) and chlorinated or fluorinated hydrocarbons (e.g., methyl chloride, methylene chloride, dichloroethane, dichloroethylene, trichloroethane, trichloroethylene, trichlorofluoromethane, and perfluorinated hydrocarbons. In some embodiments, the composition is substantially free of thermoplastic microspheres obtained from Akzo Nobel under the trade designation “EXPANCEL”. “Substantially free” of thermoplastic microspheres containing a blowing agent refers to less than 0.1, or up to 0.099, 0.075, 0.05, 0.01, or 0.005 percent by weight, based on the total weight of the aqueous dispersion. The microspheres expand when the temperature is raised and are said to coagulate aqueous polymer dispersions in U.S. Pat. No. 9,624,408 (Pietsch et al.) and U.S. Pat. No. 10,662,263 (Schmidt et al.). Advantageously, the compositions of the present disclosure do not require the addition of thermoplastic microspheres containing a blowing agent (with the concomitant increase in cost) or the application of heat to coagulate at a desired time.

The composition according to the present disclosure and/or made by the process of the present disclosure typically and advantageously may or may not be used in combination with an external coagulant, such as citric acid, lactic acid, acetic acid, or zinc sulfate. Thus, the method of making a bonded article comprising a first substrate and a second substrate, for example, when applying the composition comprises spraying, may or may not use a second part including such a coagulant in a predetermined ratio with the composition of the present disclosure.

In some embodiments, the waterborne adhesive useful for the composition or methods of the present disclosure comprises not more than 0.05, 0.01, or 0.005 weight percent of or is free of a compound which is not polymerizable by radical polymerization and which comprises at least 2 functional groups capable of reacting with at least one of a hydroxyl, epoxy, ketone, aldehyde, or acetoacetate group, the weight percentages being based on the total amount of monomer units in the acrylic polymer.

In some embodiments, the composition according to the present disclosure and/or made by the process of the present disclosure is a spray adhesive. In some embodiments, the composition according to the present disclosure and/or made by the process of the present disclosure is packaged in a spray container. Any of a variety of different spray containers may be useful for delivering the composition of the present disclosure and may be useful in the method of making a bonded article according to the present disclosure. For example, an air-assisted spray system may be useful. Examples of useful air-assisted spray systems include those obtained under the trade designation “3M Accuspray ONE Spray Gun System with Standard PPS” and “3M Accuspray Paint Spray System with PPS 2.0” from 3M Company, St. Paul, Minnesota. Thus, the spray container may be a disposable cup or cup and disposable liner attached to a spray gun with an atomizing head or nozzle. Spray can be assisted using compressed air, for example, at pressures in a range from 0.13 Megapascals (MPa) to 0.21 MPa.

In other embodiments, an airless spray system may be used for the compositions and methods of the present disclosure. Pressure pots such as one-liter capacity pots with pressure rating up to 225 psi (1.24 MPa), obtained, for example, from Apache Stainless Steel Equipment Corporation, Beaver Dam, Wisconsin can be connected to a nylon hose obtained, for example, under the trade designation “3M Cylinder Adhesive Hose” from 3M Company, St. Paul, Minnesota. The hose can be, for example, up to 8, 7, 6, 5, 4, 3, 2, or 1 meter long. A high throughput metallic spray gun obtained, for example, under the trade designations “GunJet” and “H GunJet” from Spray Systems Co., Minnetonka, Minnesota with a brass spray nozzle obtained, for example, under the trade designations “4001 UniJet”, “6501 UniJet”, “9501 UniJet”, “1100050 UniJet”, and “800050 UniJet” from Spray Systems Co. may conveniently attached to the hose. The canister can be pressurized with dry nitrogen gas or any desirable gas.

In other embodiments, aerosol cans may be used for the compositions and methods of the present disclosure. Aerosol cans can be obtained from a variety of sources, for example, from Ball Metalpack, Broomfield, Colorado, under the trade designation “Classic Tinplate Can”. Any aerosol actuator, for example, that obtained under the trade designation “Seaquist 802-24-20/0890-20FS” from Aptar, Mukwonago, Wisconsin with Buna valves obtained under the trade designation “AR-83” from Aptar, may be useful. Aerosols typically include a propellant. Examples of suitable propellants include nitrogen, carbon dioxide, ethane, propane, isobutane, normal butane, dimethyl ether, 1,1-difluoroethane, trans-1,3,3,3-tetrafluoropropene, and mixtures thereof. Typically, liquid aerosol propellants such as propane, butane, and isobutane are added to the composition or spray adhesive composition in an amount ranging from about 5% to about 45% by weight, based on the total weight of the composition. When gases such as nitrogen and carbon dioxide are used as the propellant, the gas propellant is typically present in an amount ranging up to about 10%, 8%, 6%, 5%, or 2% by weight, based on the total weight of the composition.

In some embodiments, the composition of the present disclosure can be useful in a tape and is disposed on a tape backing. Accordingly, in some embodiments, the present disclosure provides a tape comprising the composition of the present disclosure as described above in any of its embodiments. As described above, the composition of the present disclosure can be coated on a tape backing and dried or allowed to dry to provide the tape. The tape backing can be any polymeric film material, paper, or a polymer-cloth laminate. Polymeric materials suitable for the backing include polyesters (e.g., poly(ethylene terephthalate)); polyolefins (e.g., polyethylene, polypropylene); ethyl cellulose film; cellulose esters (e.g., cellulose acetate, cellulose acetate butyrate, and cellulose propionate); polyvinylidene chloride-vinyl chloride and/or acrylonitrile polymers such as saran; vinyl chloride polymers (e.g., poly(vinyl chloride) and copolymers of vinyl chloride and vinyl acetate); polyfluoroethylenes (e.g., polytetrafluoroethylene and polytrifluorochloroethylene); polyvinyl alcohol; polyamides such as nylon; polystyrenes such as the copolymers of styrene and isobutylene; regenerated cellulose; benzyl cellulose; cellulose nitrate; gelatin; glycol cellulose; flexible acrylate and methacrylates; urea aldehyde films; polyvinyl acetal; and polyvinyl butyral. The adhesive can be present on tape backing in any useful amount, for example, in a range from 20 grams per square meter (gsm) to 150 gsm. Useful amounts of adhesive can be, for example, 20 gsm to 60 gsm, 20 gsm to 40 gsm, or 40 gsm to 60 gsm for paper and polymer film backings. For polymer/cloth laminates, useful amounts of adhesive can be, for example, 80 gsm to 150 gsm.

In some embodiments, the polymer film tape backing of the tape is surface treated before the composition is applied. Useful surface treatments include electrical discharge in the presence of a suitable reactive or non-reactive atmosphere (e.g., plasma, glow discharge, corona discharge, dielectric barrier discharge or atmospheric pressure discharge), ultraviolet light exposure, electron beam exposure, flame discharge, and scuffing. The surface treatment can be applied as the polymer film backing is being made or in a separate process. In some embodiments, the tape includes optional low-adhesion backsize. Low-adhesion backsizes are known to one of ordinary skill in the art can be made from a variety of materials (e.g., a silicone, fluorochemical, or carbamate). In some embodiments, the backing is a release liner, and the tape is a transfer tape.

The present disclosure provides an article that comprises a first substrate and a second substrate bonded together with a composition of the present disclosure and a method of making such an article. The surfaces of the first substrate and the second substrate may be any desired material. In some embodiments, at least one of the surfaces of the first substrate or the surface of the second substrate comprises at least one of metal, glass, a polymer, paper, a painted surface, a nonwoven or woven fabric, or a composite. The material of the surface of the first and second substrate may be found throughout the substrate, or the surface may include a different material from the bulk of the substrate. In some embodiments, the surface of the first substrate and/or second substrate comprises at least one of metal (e.g., steel, stainless steel, or aluminum), glass (e.g., which may be coated with indium tin oxide, for example,), a polymer (e.g., a plastic, rubber, thermoplastic elastomer, or thermoset), paper, a painted surface, or a composite. A composite material may be made from any two or more constituent materials with different physical or chemical properties. When the constituents are combined to make a composite, a material having characteristics different from the individual components is typically achieved. Some examples of useful composites include fiber-reinforced polymers (e.g., carbon fiber reinforced epoxies and glass-reinforced plastic); metal matrix compositions, and ceramic matrix composites. The surface of at least one of the first or second substrates may include polymers such as polyolefins (e.g., polypropylene, polyethylene, high density polyethylene, blends of polypropylene), polyamide 6 (PA6), acrylonitrile butadiene styrene (ABS), polycarbonate (PC), PC/ABS blends, polyvinyl chloride (PVC), polyamide (PA), polyurethane (PUR), thermoplastic elastomers (TPE), polyoxymethylene (POM), polystyrene, polyester (e.g., polyethylene terephthalate), poly(methyl) methacrylate (PMMA), and combinations thereof. The surface of at least one of the first or second substrate may also include a metal coating on such polymers. In some embodiments, at least one of the first or second substrate comprises a transparent material such as glass or a polymer (e.g., acrylic or polycarbonate).

In some embodiments, at least one of the first substrate or second substrate is a woven or nonwoven fabric. The term “nonwoven” refers to a material having a structure of individual fibers or threads that are interlaid but not in an identifiable manner such as in a knitted fabric. Examples of nonwoven webs include spunbond webs, spunlaced webs, needle-punched webs, airlaid webs, meltblown web, and bonded carded webs. Useful nonwovens may be made of natural fibers (e.g., wood or cotton fibers), synthetic fibers (e.g., thermoplastic fibers), or a combination of natural and synthetic fibers. Examples of suitable materials for forming thermoplastic fibers include polyolefins (e.g., polyethylene, polypropylene, polybutylene, ethylene copolymers, propylene copolymers, butylene copolymers, and copolymers and blends of these polymers), polyesters, and polyamides. The fibers may also be multi-component fibers, for example, having a core of one thermoplastic material and a sheath of another thermoplastic material. Examples of woven fabrics include twill and canvas.

In some embodiments, at least one of the first substrate or the second substrate is a low surface energy substrate. The term “low surface energy substrate” is meant to refer to those substrates having a surface energy of less than 34 dynes per centimeter. Included among such materials are polypropylene, polyethylene [e.g., high density polyethylene (HDPE), low density polyethylene (LDPE), and liner low density polyethylene (LLDPE)], and blends of polypropylene (e.g., PP/EPDM, TPO). In some embodiments, at least one of the first substrate or the second substrate is a medium surface energy substrate. The term “medium surface energy substrates” is meant to refer to those substrates having a surface energy in a range from 34 to 70 dynes per centimeter, typically from 34 to 60 dynes per centimeter, and more typically from 34 to 50 dynes per centimeter. Included among such materials are polyamide 6 (PA6), acrylonitrile butadiene styrene (ABS), polycarbonate (PC)/ABS blends, PC, PVC, polyamide (PA), polyurethane (PUR), thermoplastic elastomers (TPE), polyoxymethylene (POM), polystyrene, and poly(methyl methacrylate) (PMMA). The surface energy is typically determined from contact angle measurements as described for example in ASTM D7490-08.

The composition or spray adhesive composition of the present disclosure can be useful in a variety of applications. For example, the composition can be useful for bonding geotextiles. Geotextiles are typically made from nonwoven or woven fabric and may be made from low surface energy materials such as polyolefins. Examples of materials useful as geotextiles include polypropylene and polyethylene terephthalate (PET). The composition can also be useful for graphics attachment (e.g., branding or information graphics) and plastic assembly. Examples of useful substrate surfaces for graphics attachment include polypropylene, ABS, PC, aluminum, steel, and painted surfaces. Graphic films can be made, for example, from PUR or PVC. The composition of the present disclosure can also be useful for bonding dissimilar materials together. In some of these embodiments, the first substrate comprises a metal, and the second substrate comprises a rubber or plastic. In some embodiments, the first and second substrates are dissimilar plastics. The composition of the present disclosure can also be useful for foam lamination in which either the first or second substrate is a foam (e.g., a polymer foam such as polyurethane, EPDM, and polyethylene foam). The composition of the present disclosure can also be useful for packaging in which either the first or second substrate is a paper (e.g., polymer-coated paper) or paperboard.

### Some Embodiments of the Disclosure

In a first embodiment, the present disclosure provides a composition comprising:
an acrylic polymer comprising monomer units of at least one of an alkyl acrylate or alkyl methacrylate, wherein alkyl has at least 8 carbon atoms, and at least 0.5 percent by weight of monomer units comprising a carboxylic acid, sulfonic acid, or phosphonic acid, based on the total weight of monomer units in the acrylic polymer;
a first tackifier;
an emulsifier; and
water,
   wherein the composition is an emulsion of the acrylic polymer and the tackifier in water.

In a second embodiment the present disclosure provides the composition of the first embodiment, wherein if the first tackifier is an aromatic hydrocarbon having an aliphatic:aromatic hydrogen ratio or aliphatic:(unsaturated and aromatic) hydrogen ratio of in a range from 75 to 80 as determined by proton nuclear magnetic resonance spectroscopy, at least one of the first tackifier is present in an amount of not more than 15.0 parts per 100 parts of the acrylic polymer or the monomer units comprise at least 15, 20, 25, 30, 40, or 50 percent by weight of an alkyl acrylate or an alkyl methacrylate in which alkyl has at least 10 carbon atoms.

In a third embodiment, the present disclosure provides the composition of the first or second embodiment, wherein alkyl has at least 10, 11, or 12 carbon atoms.

In a fourth embodiment, the present disclosure provides the composition of any one of the first to third embodiments, wherein the acrylic polymer further comprises at least one of second monomer units of at least one of a C₄-C₉ alkyl acrylate or C₄-C₉ alkyl methacrylate or third monomer units of a high T_{g} monomer that when polymerized provides a homopolymer having a glass transition temperature of at least 20° C.

In a fifth embodiment, the present disclosure provides the composition of any one of the first to fourth embodiments, wherein the emulsion comprises particles comprising both the tackifier and the acrylic polymer.

In a sixth embodiment, the present disclosure provides the composition of any one of the first to fifth embodiment, wherein the tackifier is present in the composition in a range from one part to 30 parts per one hundred parts of acrylic polymer.

In a seventh embodiment, the present disclosure provides the composition of any one of the first to sixth embodiments, wherein the acrylic polymer further comprises monomer units of a second monomer comprising at least one of a C₄-C₉ alkyl acrylate or C₄-C₉ alkyl methacrylate.

In an eighth embodiment, the present disclosure provides the composition or spray adhesive composition of any one of the first to seventh embodiments, wherein the acrylic polymer further comprises monomer units of a high T_{g} monomer that when polymerized provides a homopolymer having a glass transition temperature of at least 20° C., wherein the high Tg monomer has an alkyl group with at least five carbon atoms.

In a ninth embodiment, the present disclosure provides the composition of any one of the first to eighth embodiments, wherein the acrylic polymer further comprises monomer units of a polar monomer including at least one ketone, amide, amine, alcohol, or a combination thereof.

In a tenth embodiment, the present disclosure provides the composition of any one of the first to ninth embodiments, wherein alkyl has 8 to 20, 10 to 20, 12 to 20, or 12 to 16 carbon atoms.

In an eleventh embodiment, the present disclosure provides the composition of any one of the first to tenth embodiments, wherein the acrylic polymer further comprises monomer units of an acrylate or methacrylate having more than one acrylate or methacrylate group.

In a twelfth embodiment, the present disclosure provides the composition of any one of the first to eleventh embodiments, wherein the composition comprises a second tackifier which differs from the first tackifier in at least one of molecular weight, softening point as measured using a ring and ball apparatus, or aliphatic:aromatic hydrogen ratio or aliphatic:(unsaturated and aromatic) hydrogen ratio.

In a thirteenth embodiment, the present disclosure provides the composition of any one of the first to twelfth embodiments, further comprising a base.

In a fourteenth embodiment, the present disclosure provides the composition of the first to thirteenth embodiments, wherein the composition is a spray adhesive composition, which may be packages in a spray container.

In a fifteenth embodiment, the present disclosure provides the composition or spray adhesive composition of any one of the first to fourteenth embodiments, further comprising a propellent.

In a sixteenth embodiment, the present disclosure provides the composition or spray adhesive composition of any one of the first to fifteenth embodiments, wherein the high Tg monomer comprises at least one of isobornyl (meth)acrylate (IBO(M)A), trimethylcyclohexyl (meth)acrylate, tert-butyl cyclohexyl (meth)acrylate, or dicyclopentanyl (meth)acrylate.

In a seventeenth embodiment, the present disclosure provides the composition of any one of the first to sixteenth embodiments, wherein the first tackifier is an aromatic hydrocarbon resin with at least one of a aliphatic:aromatic hydrogen ratio or aliphatic:(unsaturated and aromatic) hydrogen ratio of less than 50 or a molecular weight of at least 1200 grams per mole.

In an eighteenth embodiment, the present disclosure provides the composition of any one of the first to seventeenth embodiments, wherein the emulsion comprises particles having a size in a range from 50 nanometers to 50 micrometers, from 50 nanometers to 5 micrometers, or from 200 nanometers to 10 micrometers.

In a nineteenth embodiment, the present disclosure provides the composition of any one of the first to eighteenth embodiments, wherein the first tackifier is a hydrogenated aromatic hydrocarbon resin.

In a twentieth embodiment, the present disclosure provides the composition or spray adhesive composition of any one of the first to nineteenth embodiments, wherein the acrylic polymer is not a core-shell polymer.

In a twenty-first embodiment, the present disclosure provides the composition of any one of the first to twentieth embodiments, wherein the first tackifier has a molecular weight of at least 1200 grams per mole.

In a twenty-second embodiment, the present disclosure provides the composition of any one of the first to twentieth embodiments, wherein the first tackifier has an aliphatic:aromatic hydrogen ratio or aliphatic:(unsaturated and aromatic) hydrogen ratio of not more than 34 as determined by proton nuclear magnetic resonance spectroscopy, and wherein the composition comprises the second tackifier, and wherein the second tackifier has an aliphatic:aromatic hydrogen ratio or aliphatic:(unsaturated and aromatic) hydrogen ratio of greater than 34 as determined by proton nuclear magnetic resonance spectroscopy.

In a twenty-third embodiment, the present disclosure provides the composition of the twenty-second embodiment, wherein the second tackifier is a hydrogenated aromatic hydrocarbon resin.

In a twenty-fourth embodiment, the present disclosure provides the composition of any one of the first to twenty-third embodiments, comprising not more than 0.05, 0.01, or 0.005 weight percent of or which is free of a compound which is not polymerizable by radical polymerization and which comprises at least 2 functional groups capable of reacting with at least one of a hydroxyl, epoxy, ketone, aldehyde, or acetoacetate group, the weight percentages being based on the total amount of monomer units in the acrylic polymer.

In a twenty-fifth embodiment, the present disclosure provides a process for making the composition of any one of the first to twenty-fourth embodiments, the process comprising:
combining the tackifier and the at least one alkyl acrylate or alkyl methacrylate to form a solution;
combining the solution with the water and the emulsifier; and
polymerizing the at least one alkyl acrylate or alkyl methacrylate to form an emulsion with droplets that include both the acrylic polymer and the tackifier.

In a twenty-sixth embodiment, the present disclosure provides the process of the twenty-fifth embodiment, wherein a second monomer comprising at least one of a C₄-C₉ alkyl acrylate or C₄-C₉ alkyl methacrylate is combined with the tackifier and the at least one alkyl acrylate or alkyl methacrylate.

In a twenty-seventh embodiment, the present disclosure provides the process of the twenty-fifth or twenty-sixth embodiment, wherein a high T_{g} monomer that when polymerized provides a homopolymer having a glass transition temperature of at least 20° C. is combined with the tackifier and the at least one alkyl acrylate or alkyl methacrylate. In this embodiment, the high T_{g} monomer can be isobornyl (meth)acrylate (IBO(M)A), trimethylcyclohexyl (meth)acrylate, tert-butyl cyclohexyl (meth)acrylate, or dicyclopentanyl (meth)acrylate.

In a twenty-eighth embodiment, the present disclosure provides the process of any one of the twenty-fifth to twenty-seventh embodiments, wherein a polar monomer including at least one ketone, amide, amine, alcohol, or a combination thereof is combined with the tackifier and the at least one alkyl acrylate or alkyl methacrylate.

In a twenty-ninth embodiment, the present disclosure provides the process of any one of the twenty-fifth to twenty-eighth embodiments, wherein alkyl has 8 to 20, 10 to 20, 12 to 20, or 12 to 16 carbon atoms.

In a thirtieth embodiment, the present disclosure provides the process of any one of the twenty-fifth to twenty-ninth embodiments, wherein an acrylate or methacrylate having more than one acrylate or methacrylate group is combined with the tackifier and the at least one alkyl acrylate or alkyl methacrylate.

In a thirty-first embodiment, the present disclosure provides the process of any one of the twenty-fifth to thirtieth embodiments, wherein the droplets have a size in a range from 50 nanometers to 50 micrometers, from 50 nanometers to 5 micrometers, or from 200 nanometers to 10 micrometers.

In a thirty-second embodiment, the present disclosure provides a method of making a bonded article comprising a first substrate and a second substrate, the method comprising: applying the composition of any one of the first to twenty-fourth embodiments on at least one of the first substrate or the second substrate; and adhering the first substrate and the second substrate together.

In a thirty-third embodiment, the present disclosure provides the method of the thirty-second embodiment, wherein applying comprises spraying.

In a thirty-fourth embodiment, the present disclosure provides the method of any one of the thirty-second to thirty-third embodiments, wherein at least one of the first substrate or the second substrate is a nonwoven or woven fabric.

In a thirty-fifth embodiment, the present disclosure provides the method of any one of the thirty-second to thirty-fourth embodiment, at least one of the first substrate or the second substrate is a low surface energy substrate.

In order that this disclosure can be more fully understood, the following examples are set forth. It should be understood that these examples are for illustrative purposes only and are not to be construed as limiting this disclosure in any manner.

### EXAMPLES

Unless otherwise noted, all parts, percentages, ratios, etc. in the Examples and the rest of the specification are by weight. The following abbreviations are used in this section: min=minutes, s=second, h=hour, g=gram, mg=milligrams, mL=milliliters, m=meter, centimeter=cm, mm=millimeter, ° C.=degrees Celsius, ° F.=degrees Fahrenheit, MPa=megapascals, N=Newtons, oz=ounce, sqft=square foot, ft=feet, psi=pounds per square inch, and kPa=kilopascals.

Table 1 (below) lists materials used in the examples and their sources.

TABLE 1
Materials List

| DESIGNATION | DESCRIPTION |
|---|---|
| EHA | Ethylhexyl acrylate, obtained from BASF, Florham Park, New Jersey |
| IOA | Isooctyl acrylate, obtained from 3M Company, St. Paul, MN |
| OAIB | Octyl acrylate isomer blend prepared as described in U.S. Pat. No. 9,102,774 |
| | (Clapper et al.) |
| DAIB | Dodecyl acrylate isomer blend prepared as described in U.S. Pat. No. 9,102,774 |
| | (Clapper et al.) |
| AA | Acrylic acid, obtained from BASF |
| MAA | Methacrylic acid, obtained from Alfa Aesar, Ward Hill, Massachusetts |
| CEA | Carboxyethyl acrylate, obtained from Solvay |
| IBOA | Isobornyl acrylate, obtained from Sans Ester, New York, New York |
| DDM | t-dodecyl mercaptan, Sigma Aldrich, St. Louis, MO |
| DAAM | Diacetone acrylamide, obtained from Alfa Aesar |
| AAEM | Acetoacetoxy ethyl methacrylate, obtained from TCI America, Portland, Oregon |
| EHTL | 2-Ethylhexyl Thioglycolate, obtained from TCI America |
| HDDA | 1,6-Hexanediol diacrylate, obtained from Alfa Aesar |
| P100 | Fully hydrogenated C9 hydrocarbon tackifier, obtained under the trade name |
| | “ARKON P100”, from Arakawa, Osaka, Japan |
| P125 | Fully hydrogenated C9 hydrocarbon tackifier, obtained under the trade name |
| | “ARKON P125”, from Arakawa |
| P140 | Fully hydrogenated C9 hydrocarbon tackifier, obtained under the trade name |
| | “ARKON P140”, from Arakawa |
| M100 | Partially hydrogenated C9 hydrocarbon tackifier, obtained under the trade name |
| | “ARKON M100”, from Arakawa |
| M115 | Partially hydrogenated C9 hydrocarbon tackifier, obtained under the trade name |
| | “ARKON M115”, from Arakawa |
| M135 | Partially hydrogenated C9 hydrocarbon tackifier, obtained under the trade name |
| | “ARKON M135”, from Arakawa |
| 6108 | Partially hydrogenated C9 hydrocarbon tackifier, obtained under the trade name of |
| | “REGALREZ 6108” from Synthomer USA |
| 3102 | Partially hydrogenated C9 hydrocarbon tackifier, obtained under the trade name of |
| | “REGALREZ 3102” from Synthomer USA |
| R7100 | Partially hydrogenated C9 hydrocarbon tackifier, obtained under the trade name of |
| | “REGALITE R7100” from Synthomer USA |
| S7125 | Partially hydrogenated C9 hydrocarbon tackifier, obtained under the trade name of |
| | “REGALITE S7125” from Synthomer USA |
| 240 | Non-hydrogenated C9 hydrocarbon tackifier, obtained under the trade name of |
| | “NEVCHEM 240” from Neville USA |
| TH160 | Hydrogenated terpene phenol tackifier, obtained under the trade name of “TH160” |
| | from Yasuhara Japan |
| TO125 | Aromatic modified terpene resin, obtained under the trade name of “TO125” from |
| | Yasuhara Japan |
| D160 | Rosin ester, obtained under the trade name of “Pensel D” from Arakawa |
| KPS | Potassium persulfate 1, obtained from Sigma Aldrich, St. Louis, Missouri |
| APS | Ammonium persulfate (NH₄)₂S₂O₈, from Sigma Aldrich |
| FF6 | FF6 reducer from BruggemannChemical U.S., Inc. |
| VAZO 52 | 2,2′-azobis(2,4-dimethylpentanenitrile) , E. I. DuPont de Nemours Co |
| VAZO 64 | 2,2′-azobis (isobutyronitrile), from Sigma Aldrich |
| VAZO 88 | 1,1′-azobis(cyclohexanecarbonitrile), E. I. DuPont de Nemours Co |
| A75 | Benzoyl peroxide initiator, Sigma Aldrich, trade designation “LUPEROX A75” |
| HITENOL | Polyethylene nonylpropenyl phenyl ether ammonium sulfate surfactant, 25% by |
| BC-1025 | weight in water, obtained under the trade name “HITENOL BC-1025”, from |
| | Montello Inc., Kyoto Japan |
| AR1025 | Polymerizable surfactant, obtained under the trade designation “HITENOL |
| | AR1025”, from Montello Inc, Sand Springs, OK |
| KH1025 | Polymerizable surfactant, obtained under the trade designation “HITENOL |
| | KH1025”, from Montello Inc, Sand Springs, OK |
| WS-500 | Oxazoline crosslinker from Nippon Shakubai |
| AeBP | Photocrosslinker from 3M |
| HOLDFAST 70 | Cylinder Adhesive, obtained under the trade designation “HOLDFAST 70”, from |
| | 3M Company, Springfield, Missouri |
| IBOMA | Isobornyl methacrylate, obtained from Solvay |
| CHMA | Cyclohexyl methacrylate, obtained from BASF |
| IBMA | Isobutyl methacrylate, obtained from Sigma Aldrich |
| TBMA | Tert-butyl methacrylate, obtained from BASF |
| TBCHA | Tert-butyl cyclohexyl acrylate, obtained from Miwon |
| TBCHMA | Tert-butyl cyclohexyl methacrylate, obtained from Miwon |

### Test Methods

### pH Measurement

pH was measured using pH two sets of pH paper strips (BAKER-pHIX pH 7.0-14, from J. T. Baker, Phillipsburg, New Jersey; “Cat. No. 8884-1” pH Test Strip 2-9, from Ricca Chemical Company, Arlington, Texas) and taking an average of the results.

### Preparation of Samples for Overlap Shear and Peel Testing and Shear Adhesion Failure Test

Desired substrates were chosen and cut into 1-inch-wide strips. The adhesive was either applied with the Air-Assisted Spray or Airless Spray systems (see description below) at wet coat weights of roughly 8-12 g/sqft. Once the adhesive was sprayed onto the substrate, the bonds were joined within 30-120 s, either rolled with a hand roller or a binder clip, allowed to dwell for 16-24 h, and then tested on a tensile tester (obtained under the trade designation “QTEST_5”, from MTS Systems Corporation, Eden Prairie, Minnesota). All numbers listed in the tables below are averages of 3-5 tests.

### Adhesive Coating and Making PSA Tape

The waterbome adhesives were coated directly on a 2 mil PET film with a lab coater and dried in an oven at 70 C for 20 min or 80 C for 15 min. The PSA dry thickness was about 2 mil to 2.5 mil. Then the PSA was covered with a release liner.

### UV Curing

An LH10 fusion Processor with D bulb was used to cure a few of the PSAs. First, the liner was removed, then the PSA was exposed to UV for curing, with 100% power and a belt speed about 107 ft/min. This resulted in curing with UVA, UVB and UVC. The UVB dose was about 120 mJ/cm², the UVA dose was about 375 mj/cm² and the UVC dose was about 14 mJ/cm².

### PSA Testing

### Peel Adhesion Testing

PSA strips (about 0.5 in by 8 in) were cut from a PSA tape, and then separately laminated on a clean stainless steel (SS, ChemInstruments, 510 Commercial Dr, West Chester Township, OH, USA) or polypropylene (PP, P-PPN-0187-1, Aeromat Plastics, Burnsville, MN, USA) panel with a 2 kg roller. After dwelling the PSA strip after some time (see Table 3), peel adhesion was tested with an IMPASS peel testing instrument (model TL-2300 from IMASS Inc., Strongsville, Ohio). The peel angel was 180 degrees, and peel speed was either 8 in/min or 12 in/min as reported in the Table.

### Static Shear Testing

PSA strips (about 0.5 in by 8 in, or 1 in by 8 in) were cut from a PSA tape, and then laminated to a SS shear panel 9 ChemInstruments, 510 Commercial Dr, West Chester Township, OH, USA) with a 2 kg roller. The detailed contact area and weight are described in performance table. The PSA strip was then folded around a hanger and fixed with a staple. The prepared shear samples were then hung with a weight using a shear testing equipment. The time for the PSA strip to fall off the panel is reported as shear. If the PSA did not fail at 10K min, the shear is reported as 10K min.

### Creep Resistance Testing

PSA strips (about 1 in by 8 in) were cut from a PSA tape, and then laminated to a SS testing panel with a 2 kg roller with a contact area of 1 in by 1 in. The rest of the tape was then flipped 180 degrees, folded at the tape bottom, put on a creep testing equipment, and hang with a 100 g weight. The time for the PSA strip to fall off the panel is reported as creep resistance.

### Haze Testing

Haze testing was carried out with Easymatch QC software of UltraScan Pro instrument from Hunter Associates Lab Inc. To do testing, first the haze of an optical clear glass was measured. Then a piece of PSA was cut from adhesive sheet coated on liner, the liner was removed, and the adhesive sheet was directly laminated on the optical clear glass for haze testing. The lower the haze value; the clearer the PSA.

### ¹H NMR Spectra Acquisition and Analysis

A suitable amount of analyte (8 mg-40 mg) such that suitable signal to noise was achieved for analysis was dissolved in CDCl₃ (700-800 μL) and dispensed into an NMR tube. ¹H NMR spectra were collected using a 15° tip angle, three-second acquisition time, and no recycle delay on a Bruker Avance III 300 MHz instrument or a Bruker Avance III 500 MHz instrument equipped with a broadband cryoprobe (Bruker, Billerica, MA, USA). Spectra were processed using ACD Labs NMR software (ACD Labs, Toronto, Ontario, Canada): adjusting Ph0 and Ph1, appropriate baseline correction, and integration of the aromatic (6.5-8.0 ppm), unsaturated (4.5-6.5 ppm), and aliphatic region (0.5-2.5 ppm). Integral values were normalized by dividing by the approximate number of protons per area: aromatic (5), unsaturated (2), and aliphatic (4). The resulting normalized values were then used to calculate mol % of each functionality. To calculate the aliphatic to aromatic and unsaturated ratio (Aliphatic/(Unsaturated & Aromatic) Ratio), the mol % aliphatic is divided by the sum of aromatic and unsaturated mol %. To calculate the aliphatic to aromatic ratio (Aliphatic/Aromatic Ratio), the mol % aliphatic is divided by only the aromatic mol %.

### Polymer Molecular Weight Measurement

The molecular weight distribution of the compounds was characterized using gel permeation chromatography (“GPC”). The GPC equipment consisted of 1100 Series (comprised of HPLC pump, degasser, autosampler, column compartment, differential refractive index detector) from Agilent Technologies (Santa Clara, CA, USA) operated at a flow rate of 1.0 milliliter/minute using tetrahydrofuran (OMNISOLV grade, stabilized with 250 parts per million of butylated hydroxytoluene, from EMD Millipore Corporation) as eluent. The GPC column set consisted of two Styragel HR-5E columns (300 mm length×10 mm internal diameter) from Waters Corporation (Milford, MA, USA). The column compartment and differential refractive index detector were set to 40° C. The data were analyzed using Agilent GPC/SEC software from Agilent Technologies.

Dried polymer (0.11 g) was dissolved in tetrahydrofuran for seven days. The solutions were filtered through 0.45 micrometer pore size polytetrafluoroethylene syringe filters (Fisherbrand) and placed into autosampler vials. These solutions were placed into the autosampler of the GPC system for analysis. The injection volume was set to 60 microliters.

Polystyrene molecular weight standards from Agilent Technologies ranged in Mp (molecular weight at the peak apex) from 580 g/mol to 6,570,000 g/mol. The molecular weight calibration curve was of first order.

TABLE 2
Data for Tackifiers Used in Samples

| | Softening | | | Mol % | | Aliphatic/ | Aliphatic/ |
|---|---|---|---|---|---|---|---|
| | Point | | Mol % | Un- | Mol % | (Unsaturated & | Aromatic |
| Tackifier | (° C.) | Mw | Aromatic | saturated | Aliphatic | Aromatic) Ratio | Ratio |
| M135 | 135 | 1700 | 7.01 | 0.00 | 92.99 | 13.26 | 13.26 |
| M115 | 115 | 1200 | 6.52 | 0.09 | 93.39 | 14.14 | 14.33 |
| M100 | 100 | 1100 | 8.65 | 0.07 | 91.28 | 10.47 | 10.55 |
| P140 | 140 | 1700 | 1.24 | 0.03 | 98.72 | 77.24 | 79.37 |
| P125 | 125 | 1400 | 2.83 | 0.00 | 97.17 | 34.35 | 34.35 |
| P100 | 100 | 1000 | 2.47 | 0.00 | 97.53 | 39.43 | 39.43 |
| 7100 | 102 | 900^{a} | 8.1 | 0 | 91.9 | 11.36 | 9.3 |
| 7125 | 123 | 1280^{a} | 8.67 | 0 | 91.24 | 10.41 | 8.41 |

^{a}Provided by a supplier. Supplier also reports that these tackifiers are about 70% hydrogenated.

TABLE 2A
Data for Tackifiers

| | Softening | Mw | | Hydrogenation |
|---|---|---|---|---|
| | Point | from | Aliphatic/ Aromatic | degree from |
| Tackifier | (° C.) | supplier | Ratio | supplier |
| 6108 | 108 | 1460 | 2 to 10^{a} | 60% |
| 3102 | 103 | 1380 | 2 to 10^{a} | 30% |
| 240 | 140 | 1650 | 1.95 | 0% |
| TH160 | 160 | NR^{b} | NR | >95% |
| TO125 | 125 | NR | NR | NR |
| D160 | 160 | NR | NR | NR |

^{a}Estimated.
^{b}NR = not reported.

### Air Assisted Spray

Air assisted spray performance was explored using an air assisted spray system (obtained under the trade designation “3M Accuspray ONE Spray Gun System with Standard PPS” and/or “3M Accuspray Paint Spray System with PPS 2.0” from 3M Company, Lindstrom, Minnesota). The adhesive was fed through the gun with a gravity feed cup on the back and disposable 1.8 mm plastic nozzles. Air pressures were 0.14 MPa obtained from house compressed air.

### Airless Spray

Airless spray performance was explored using pressure pots (custom 1 L capacity pots with pressure rating up to 225 psi, from Apache Stainless Steel Equipment Corporation, Beaver Dam, Wisconsin) connected to a nylon hose (obtained under the trade designation “3M Cylinder Adhesive Hose” from 3M Company, Pine City, Minnesota) with a high throughput metallic spray gun (obtained under the trade designation “H GunJet” from Spray Systems Co., Minnetonka, Minnesota) with a brass spray nozzle (obtained under the trade designation “9501 UniJet” from Spray Systems Co., Minnetonka, Minnesota). The canister was pressurized to 1.24 MPa with dry nitrogen gas.

### Examples 1 to 4

Part a. Pre-Emulsion Preparation:

First, the oil phase was prepared. The monomer mixture and tackifier were added to a glass or plastic jar and mixed until the tackifier(s) had completely dissolved. After that, the chain transfer agent (t-DDM), crosslinkers (HDDA, or/and AeBP), and oil-soluble initiator were added into the oil phase and mixed well, provided these additives were part of the formulation. The weight ratio of each component was based on 100 parts of monomer as provided in the formulation table, and the total oil phase amounted to about 370 g (not including the chain transfer agent, crosslinker, and oil-soluble initiator, as these were in very small amounts). Then, the aqueous phase was prepared by mixing 240 g DI water with 17.76 g BC1025 surfactant in a beaker. Finally, a pre-emulsion was prepared by slowly adding the oil phase into the aqueous phase under mixing at 400 rpm, followed by about 40 minutes to 1 hour of mixing. Further processing was then carried out with a Waring blender (model 7012S, Waring company, at speed 7 (~25,000 rpm)) for approximately 1 minute and 20 seconds.

Part b. Polymerization:

First, the high shear mixed pre-emulsion was charged into a glass reactor equipped with an N2 purge line, a condenser, two addition ports, and a pitch blade glass agitator. It was then purged with N2 for about 30 minutes to 1 hour. The pre-emulsion in the reactor was heated to about 60° C. The initiator was flushed into the reactor with water (i.e., 0.705 g KPS, ~6 g H2O). The polymerization was carried out at 60° C. for about 1.5 to 2 hours, after which the temperature was increased to 70° C. to polymerize for about 3 hours. After the polymerization, the reactor was cooled to room temperature, and NH3 was added to neutralize the emulsion to a pH of 4 to 7. The adhesive was then filtered into a container using a cheesecloth.

TABLE 3

| | Examples | | | | | |
|---|---|---|---|---|---|---|
| | EX-1 | | EX-2 | | EX-3 | |
| Chemical | Ratio | W (g) | Ratio | W (g) | Ratio | W (g) |
| IOA | 96.00% | 322.91 | 96.00% | 308.87 | 96.00% | 244.52 |
| DAIB | 0 | 0 | 0 | 0 | 20.00% | 64.35 |
| AA | 1.000% | 3.36 | 1.000% | 3.22 | 1.000% | 3.22 |
| MAA | 1.00% | 3.36 | 1.00% | 3.22 | 1.00% | 3.22 |
| CEA | 2.00% | 6.73 | 2.00% | 6.43 | 2.00% | 6.43 |
| P100 | 10.00% | 33.64 | 15.00% | 48.26 | 15.00% | 48.26 |
| DDM | 0.04% | 0.673 | 0.04% | 0.643 | 0.04% | 0.643 |
| HDDA | 0.07% | 1.178 | 0.07% | 1.126 | 0.07% | 1.126 |
| DAAM | | | | | | |
| BC-1025 (g)^{a} | 1.20% | 17.76 | 1.20% | 17.76 | 1.20% | 17.76 |
| H2O-1 | | 240.00 | | 240.00 | | 240.00 |
| KPS | 0.200% | 0.6430 | 0.200% | 0.6430 | 0.200% | 0.6430 |
| H2O-2 | | 6.0000 | | 6.0000 | | 6.0000 |

^{a}The percentage is based on pure surfactant. The weight is based on the 25% surfactant in solution.

Examples 1 to 3 were tested using the test methods described above. The results are shown in Table 4, below.

TABLE 4

| | 24 h SS peel (8 | | 24 h PP peel (8 | | RT shear (min, 0.5 in*0.5 | |
|---|---|---|---|---|---|---|
| | in/min) | | in/min) | | in*1 kg) | |
| | Ave. | Stdev. | Ave. | Stdev. | 1 | 2 |
| Ex. 1 | 67 | 8 | 57 | 1 | 248 | 283 |
| Ex. 2 | 78 | 5 | 64 | 2 | 144 | 560 |
| Ex. 3 | 53 | 1 | 58 | 1 | 275 | 333 |

### Examples 4 to 6

Part A (pre-emulsion preparation) was carried out as described for Examples 1 to 4, Part A. The total oil phase was about 370 grams. For Part B (polymerization), about 80% pre-emulsion was charged into a feeding tank, and then it was purged with nitrogen for about one hour under mixing. About 20 wt % pre-emulsion was charged into a reactor, which was then purged with nitrogen for about 30 minutes to 1 hour. The pre-emulsion was heated to 70° C. The initiator, consisting of approximately 0.63 g potassium persulfate and 6 g water, was added. After several minutes, the remaining pre-emulsion was started to be fed into the reactor over the course of about 100 minutes. After the feeding was complete, the reaction continued for another 2 hours. The reactor was then cooled to room temperature, and NH₃ was added to neutralize the emulsion to a pH of about 4 to 7. Finally, the emulsion was filtered using a cheesecloth. The amounts are shown in Table 5, below.

### Example 7

The preparation of the pre-emulsion was similar to Examples 4 to 6, except that the total oil phase was about 347 g instead of 370 g (as shown in the formulation table). For polymerization, the high shear mixed pre-emulsion was charged into the reactor, which was then purged and bubbled with nitrogen for about 30 minutes. After that, the temperature was increased to 35° C., and water-soluble initiators were charged into the reactor to start the exotherm. The exotherm peak reached about 38.5° C. within approximately 28 minutes. Following that, the polymerization was carried out at 70° C. for 3 hours and then at 80° C. for 2 hours. The cooling of the emulsion, filtering, and neutralization were carried out in the same manner as described for Examples 4 to 6.

TABLE 5

| | Examples | | | | | | | |
|---|---|---|---|---|---|---|---|---|
| | EX-4 | | EX-5 | | EX-6 | | EX-7 | |
| Chemical | Ratio | W (g) | Ratio | W (g) | Ratio | W (g) | Ratio | W (g) |
| OAIB | 98.5% | | 73.5% | | | | 47.0% | 141.82 |
| DAIB | | | 25.0% | | | | 50.0% | 150.87 |
| IBOA | | | | | 15.0% | | | |
| EHA | | | | | 83.5% | | | |
| AA | 0.9% | | 0.90% | | 0.90% | | 1.50% | 4.53 |
| MAA | 0.6% | | 0.60% | | 0.60% | | 1.50% | 4.53 |
| M100 | 3.0% | | 3.0% | | 3.0% | | | |
| P100 | 15.0% | | 15.0% | | | | | |
| P125 | | | | | 15.0% | | 15.0% | 44.68 |
| DDM | 0.06% | | 0.06% | | 0.06% | | 0.02% | 0.30 |
| HDDA | 0.04% | | 0.04% | | 0.04% | | 0.08% | 1.207 |
| AeBP | 0.10% | | 0.10% | | 0.10% | | | |
| V88 | | | | | | | 0.15% | 0.45 |
| KH-1025 | | | | | | | 0.50% | 6.03 |
| (g)^{a} | | | | | | | | |
| BC-1025 | 1.20% | | 1.20% | | 1.20% | | | |
| (g) | | | | | | | | |
| AR1025 | | | | | | | 1.50% | 18.10 |
| (g)^{a} | | | | | | | | |
| H2O-1 | | 240.0 | | 240.0 | | 240.0 | | 233.00 |
| KPS | 0.20% | | 0.20% | | 0.20% | | | |
| APS | | | | | | | 0.20% | 0.60 |
| H2O-2 | | 6.0 | | 6.0 | | 6.0 | | 19.50 |
| FF6 | | | | | | | 0.035% | 0.11 |
| H2O-3 | | | | | | | | 3.41 |

^{a}The surfactant percentage is based on the pure surfactant. The weight is the weight of the 25% active surfactant aqueous solution.

Examples 4 to 7 were tested for adhesive performance using the test methods in Table 6, below. The results are shown in Table 6, below. “UV” indicates UV curing as described above.

TABLE 6

| | 24 h SS peel (8 | | 24 h PP peel (8 | | RT shear (min, 0.5 in*0.5 | | | | |
|---|---|---|---|---|---|---|---|---|---|
| | in/min) | | in/min) | | in*1 kg) | | | 70 C. | |
| | Ave. | Stdev. | Ave. | Stdev. | 1 | 2 | 3 | shear | visual |
| EX-4 uv | 141 | 2 | 153 | 4 | 30 | 37 | 45 | | hazy |
| EX-4 | 104 | 2 | 101 | 1 | 2 | 2 | 2 | | hazy |
| EX-5 uv | 66 | 3 | 87 | 3 | 182 | 196 | 375 | | clear |
| EX-6 uv | 71 | 3 | 123 | 4 | 823 | 530 | 1830 | >10K | Clearer |
| | | | | | | | | | than Ex4 |
| EX -7 | 50 | 0 | 68 | 1 | 845 | >1000 | >1000 | | |

### Examples 8 to 17 and Comparative Example (CE) A and B

About 75 g EHA or DAIB, 0.011 g EHTL, 0.03 g HDDA, 0.36 g of 25% AeBP, and 0.15 g VAZO 64 were added a glass jar together with 75 g ethyl acetate, then N₂ was used to remove the oxygen. The polymerization was carried out at 60° C. for 24 h in a water bath. After that about 20 g of the polymer solution was taken out and added to a glass jar, and ethyl acetate was added to dilute the polymer solid to about 40%. Then a certain amount of tackifier, shown in Table 7, was added to the jar together with heptane to dilute the solution to about 30%. Then the solution was mixed well on the roller for about 24 h. The solution mixture was then coated on a release liner and dried at 70° C. for about 2 h to obtain a dry PSA (about 3 mils thick). The haze was then measured as described above. The results are shown in Table 7, below.

TABLE 7

| | | | Tackifier part based on | |
|---|---|---|---|---|
| | Polymer | Tackifier | 100 part of polymer | Haze % D65/10 |
| EX-8 | DAIB | M100 | 25 | 0.19 |
| EX-9 | DAIB | M135 | 25 | 0.42 |
| EX-10 | DAIB | P125 | 25 | 0.37 |
| CE A | DAIB | P140 | 25 | 1.54 |
| EX-11 | EHA | M115 | 25 | 1.29 |
| EX-12 | EHA | M135 | 25 | 1.98 |
| EX-13 | EHA | P115 | 25 | 3.12 |
| EX-14 | EHA | P125 | 25 | 7.16 |
| CE B | EHA | P140 | 25 | 58.88 |
| EX-15 | EHA | P115 | 10 | 1.98 |
| EX-16 | EHA | P125 | 10 | 2.12 |
| EX-17 | EHA | P140 | 10 | 6.44 |

### Examples 18 to 20

### Pre-Emulsion Preparation:

First, the oil phase was prepared, by adding the monomer mixture and tackifier into a glass or plastic jar and mixing them until the tackifier(s) were totally dissolved. After that, the chain transfer agent (t-DDM), crosslinkers (HDDA, AeBP), oil soluble initiator were added into the oil phase and mixed well, if there ingredients are listed in the formulation table. The weight ratio of each component was based on 100 parts of monomer and is provided in Table 8, and the total oil phase was about 370 g (not including the chain transfer agent, crosslinker and oil soluble initiator). Then, the aqueous phase was prepared by mixing 240 g DI water and 17.8 g BC-1025 surfactant in a beaker. Finally, pre-emulsion was prepared by slowly adding the oil phase into the aqueous phase under mixing, followed by another 40 min to 1 h mixing (~400 rpm), and then further processing with a Warring blender at speed 7 (25,000 rpm) for about 1 min 30 second to 2 min.

### Polymerization

First, charge about 75% to 80% of the pre-emulsion into a feeding tank, and purge with N2 (e.g., ~1 h). Charge the remaining ~20 wt % to 25% pre-emulsion into a glass reactor equipped with a condenser, N2 purge liner, two addition ports and a pitch blade agitator, then purge with N2 for about 30 min to 1 h. The pre-emulsion in the reactor was then heated to about 70° C. Initiator (about 0.63 g potassium persulfate and 6 g water) was then added to the reactor. After several minutes, feeding of the remining pre-emulsion into the reactor was started and occurred over about 100 min. After feeding, the emulsion was allowed to react for another 2 h to achieve high monomer conversion. Then the reactor was cooled to room temperature, and NH3 was added to neutralize the emulsion to the desired pH of 4 to 7. The adhesive was then filtered into a container with a cheese cloth. The amounts are shown in Table 8.

### Air Assist Spray

Air assisted spray performance was explored using the 3M PPS gun or the new 3M Performance Spray Gun (Project Voltaire). The adhesive was fed through the gun with a gravity feed cup on the back and disposable 1.8 mm plastic nozzles. Air pressures ranged from 10 to 30 psi obtained from house compressed air. Bond were prepared by spraying the desired coat weight onto birch panels (or appropriate substrate, e.g. polypropylene, nylon, etc.) that had been taped off to expose a 1 in2 area. Wooden coupons were then bonded within 5 minutes of spraying and held in place with a binder clip for 16-24 hours before overlap shear testing on an MTS instrument.

### SAFT

SAFT testing was performed by spraying the adhesive onto birch wood panels which were taped off to expose one square inch. The adhesive was sprayed to a coat weight of 3-5 g/sqft and two coated birch panels were bonded and held together with a binder clip. After 16-24 h the bonded panels were placed into a 90 degF oven and a 100 g weight was hung from the bottom. The temperature of the oven was then increased by 10 degF every 10 min and the temperature at which the bond broke was recorded. If temperatures were listed at 300 degF, it means that the bonds lasted throughout the entire test as the oven temperature maximum is 300 degF.

### Overlap Shear (OLS) and Peel Testing

Overlap shear strength was tested on a tensile tester (“QTEST_5”, from MTS Systems 20 Corporation, Eden Prairie, Minnesota) with sample pulled at a rate of 5.08 cm/min. Strength at break was recorded for birch/birch and birch/polypropylene overlap shears. Peel strength was determined on a tensile tester (“QTEST_5”, from MTS Systems Corporation, Eden Prairie, Minnesota) with overlap shear samples pulled at 25.4 cm/min. Data was collected as an average of 3 to 5 samples. Overlap shear strengths were reported in megapascals (MPa) and peel strength was recorded in Newtons per 25 mm 25 (N/25 mm).

TABLE 8

| | | Examples | | | | | |
|---|---|---|---|---|---|---|---|
| | | EX-18 | | EX-19 | | EX-20 | |
| Code | Chemical | Ratio | W (g) | Ratio | W (g) | Ratio | W (g) |
| a | OAIB | 56.00% | | 56.00% | 175.59 | 56.00% | |
| b | DAIB | 25.00% | | 25.00% | 78.39 | 25.00% | |
| c | TBMA | | | | | | |
| d | IBOA | 15.00% | | 15.00% | 47.03 | 15.00% | |
| e | AA | 1.000% | | 1.000% | 3.14 | 1.000% | |
| f | MAA | 1.00% | | 1.00% | 3.14 | 1.00% | |
| g | CEA | 2.00% | | 2.00% | 6.27 | 2.00% | |
| h | P100 | 10.00% | | 15.00% | 47.03 | 15.00% | |
| i | P125 | | | 3.00% | 9.41 | 3.00% | |
| j | M100 | | | | | | |
| k^{a} | DDM | 0.06% | | 0.06% | 0.94 | 0.04% | |
| | (20%, g) | | | | | | |
| l | HDDA | 0.08% | | 0.08% | 1.254 | 0.07% | |
| | (20%, g) | | | | | | |
| m | AeBP | 0.10% | | 0.10% | 1.25 | 0.10% | |
| | (25%, g) | | | | | | |
| n | | | | | | | |
| o | V52 | | | | | | |
| p | V64 | | | | | | |
| q | V88 | | | | | | |
| r | KH-1025 | | | | | | |
| s | BC-1025 | 1.20% | 17.76 | 1.20% | 17.76 | 1.20% | 17.76 |
| t | AR-1025 | | | | | | |
| u | H2O-1 | | 240.00 | | 240.00 | | 240.00 |
| v | Na2HPO4 | | | | | | |
| w | KPS | 0.20% | 0.63 | 0.20% | 0.63 | 0.20% | 0.63 |
| x | H2O-2 | | 6.00 | | 6.00 | | 6.00 |
| y | FF6 | | | | | | |
| z | H2O-3 | | | | | | |

^{a}The ratio is based on pure DDM, HDDA, AEBP. The actual weight is based on 20% DDM, 20% HDDA, 25% AEBP in these examples in Table 8.

TABLE 9

| | OLS Birch/Birch | | | OLS Birch/Birch | | | | | | | | |
|---|---|---|---|---|---|---|---|---|---|---|---|---|
| | one sided, psi | | | two sided, psi | | | OLS Birch/PP, psi | | | OLS Birch/Nylon, psi | | |
| | 1 | 2 | 3 | 1 | 2 | 3 | 1 | 2 | 3 | 1 | 2 | 3 |
| Ex 18 | 209 | 165 | 185 | 220 | 201 | 168 | 109 | 166 | 169 | 168 | 142 | 159 |
| Ex 19 | 126 | 128 | 198 | 129 | 196 | 125 | 144 | 171 | 170 | 159 | 159 | 144 |
| Ex 20 | 201 | 190 | 205 | 232 | 251 | 196 | 185 | 150 | 174 | 164 | 195 | 181 |

Saft was 300 F. for Examples 19 and 20, not measured for 18

### Examples 21 to 26

### Part a (Pre-Emulsion Preparation):

First, the oil phase was prepared. Add monomer mixture and tackifier (see chemical A to M) in a glass or plastic jar and mix them until the tackifier(s) were totally dissolved. After that, add chain transfer agent, or/and crosslinkers or/and oil soluble initiator (see chemical A1 to F1) into the oil phase and mix well. The weight ratio of each component based on 100 parts of monomer is provided in Table. Then, the aqueous phase was prepared by mixing water and surfactant in a beaker (see chemical A2 to F2). Finally, pre-emulsion was prepared by adding the oil phase slowly into the aqueous phase under mixing (400 rpm) followed by mixing for about 40 min to 1 h. Then the pre-emulsion was further processed with a Warring blender at speed 7 (~25,000 rpm) for about 1 min 20S (model 7012S, warring company)

Part B (Polymerization): First, charge the high shear mixed pre-emulsion into a 1 literature reactor equipped with a N2 purge line, a condenser, and an addition port, and a pitch blade glass agitator. Then purge the reactor with N2 for about 30 min to 1 h under mixing (200 rpm). After that, heat the reactor to the induction temperature as shown in the formulation table. After that, add the water-soluble initiators (see chemical A3 to E3) into the reactor to start the polymerization. Then the polymerization starts to exotherm, after the exotherm peak, further polymerize the reaction at certain temperature for several hours (see the formulation Table for the details). After polymerization, the emulsion was cooled to room temperature, and NH3 was added to neutralize the emulsion to the desired pH of 4 to 7. The adhesive was then filtered into a container with a cheese cloth.

TABLE 10

| | | Example ID | | | |
|---|---|---|---|---|---|
| | | EX-21 | EX-22 | EX-23 | EX-24 |
| | Chemical | Ratio | Ratio | Ratio | Ratio |
| Oil phase ratio | | | | | |
| A | EHA | | 50.00% | | 78.00% |
| B | OAIB | | | 52.00% | |
| C | DAIB | 77.00% | 26.00% | 26.00% | |
| D | IBOA | 20.00% | 20.00% | 20.00% | 20.00% |
| E | AA | 1.50% | | | |
| F | MAA | 1.50% | 2.00% | 2.00% | 2.00% |
| G | CEA | | 2.00% | | |
| H | | | | | |
| I | P140 | 10.00% | 7.50% | 5.00% | 7.50% |
| J | M135 | 5.00% | 7.50% | 10.00% | 7.50% |
| K | DDM | 0.00% | 0.02% | 0.02% | |
| L | HDDA | 0.08% | 0.08% | 0.08% | 0.06% |
| A1 | Vazo 64 | 0.20% | | | |
| B1 | Luperox A75 | 0.15% | | | |
| C1 | Vazo 88 | | 0.15% | 0.15% | 0.15% |
| Aqueous phase | KH1025 | 0.50% | 0.50% | 0.50% | 0.50% |
| ratio | AR1025 | 1.50% | 1.50% | 1.50% | 1.50% |
| | H2O-1 | | | | |
| Water soluble | APS | | 0.200% | 0.200% | 0.200% |
| initiator ratio | FF6 | | 0.045% | 0.045% | 0.045% |

Addition (g)

| | | | | | |
|---|---|---|---|---|---|
| | Oil phase (g) | 347 | 347 | 347 | 347 |
| | Aqueous phase | | | | |
| A2 | KH-1025 (g) | 6.03 | 6.03 | 6.03 | 6.03 |
| B2 | AR-1025 (g) | 18.1 | 18.1 | 18.1 | 18.1 |
| C2 | H20 | 233 | 233 | 233 | 233 |
| | Water or water | | | | |
| | soluble initiator | | | | |
| A3 | APS | | 0.603 | 0.603 | 0.603 |
| B3 | H2O-2 | 15 | 15 | 15 | 15 |
| C3 | FF6 | | 0.136 | 0.136 | 0.136 |
| D3 | H2O-3 | 5 | 5 | 5 | 5 |
| Polymerization | Inuduction T | 60 C. | 35 C. | 35 C. | 35 C. |
| condition | | | After | After | After |
| | | | exotherm | exotherm | exotherm |
| | | | peak T | peak T | peak T |
| | Polymerization | 60 C./5 h & | (52 C.), | (47 C.), | (49 C.), |
| | | 75 C./15 h | polymerize | polymerize | polymerize |
| | | | 70 C./3 h & | for 70 C./3 h | for 70 C./3 h |
| | | | 80 C./2 h | & 80 C./2 h | & 80 C./2 h |

TABLE 11

| PSA ID | | EX-21 | EX-22 | EX-23 | EX-24 |
|---|---|---|---|---|---|
| 24 h SS peel (oz/in, | Ave | 70 | 83 | 76 | 64 |
| 12 in/min) | Stdev | 2 | 2 | 0 | 2 |
| | FM | AF | AF | AF | AF |
| 24 h PP peel (oz/in, | Ave | 100 | 95 | 101 | 103 |
| 12 in/min) | Stdev | 2 | 2 | 3 | 2 |
| | FM | AF | AF | AF | AF |
| RT SS shear (min, | Shear 1 | 1,083 | 10,000 | 10,000 | 4,875 |
| 0.5 in*1 in*1 Kg) | Shear 2 | 1,147 | 10,000 | 10,000 | 4,835 |
| | Shear 3 | 1,277 | 9,777 | 10,000 | 5,570 |
| | FM | CF | CF | | CF |
| 70 C. SS shear (min, | Shear 1 | | 10,000 | | |
| 1 in*1 in*1 Kg) | Shear 2 | | 10,000 | | |
| | Shear 3 | | 10,000 | | |
| | FM | | | | |

TABLE 12

| | | PSA ID | | | |
|---|---|---|---|---|---|
| | | EX-25 | | EX-25 | EX-26 |
| | | W (g) | | Ratio | Ratio |
| Oil phase | | | | | |
| A | OAIB | 150.42 | OAIB | 50.50% | 50.50% |
| B | DAIB | 89.36 | DAIB | 30.00% | 30.00% |
| C | IBOA | 53.61 | IBOA | 18.00% | 8.00% |
| D | IBOMA | 0.00 | IBOMA | | 10.00% |
| E | AA | 4.47 | AA | 1.50% | 1.50% |
| F | MAA | 4.47 | MAA | 1.50% | 1.50% |
| G | P125 | 44.68 | P125 | 15.00% | 15.00% |
| A1 | DDM (20%) | 0.30 | DDM | 0.02% | 0.02% |
| B1 | HDDA (20%) | 0.89 | HDDA | 0.06% | 0.06% |
| C1 | Vazo 88 | 0.45 | Vazo 88 | 0.15% | 0.15% |
| Aqueous phase | | | | | |
| A2 | KH-1025 | 5.96 | KH-10 | 0.50% | 0.50% |
| | (25%) | | | | |
| B2 | AR-1025 | 17.87 | AR-10 | 1.50% | 1.50% |
| | (25%) | | | | |
| C2 | H2O | 233.00 | | | |
| Initiators | | | | | |
| A3 | APS (~3%) | 0.60 | APS | 0.200% | 0.200% |
| B3 | H2O | 19.26 | H2O | | |
| C3 | FF6 (3%) | 0.13 | FF6 | 0.045% | 0.045% |
| D3 | H2O | 4.33 | H2O | | |
| | Total emulsion | 629.79 | | | |
| | Total | 302.32 | | | |
| | monomer | | | | |
| | Total oil | 347.00 | | | |
| | H2O | 274.47 | | | |
| | Designed solid | 56.4% | | | |
| Polymerization | Induction | 35 C. | | | |
| condition | temperature | | | | |
| | Polymerization | After exotherm, | | | |
| | | 70 C./3 h | | | |
| | | & 80 C./2 h | | | |

TABLE 13

PSA ID

| | | |
|---|---|---|
| PSA clarity | EX-25 | EX-26 |

| | | | |
|---|---|---|---|
| 24 h SS peel | Ave | 62 | 67 |
| (oz/in, 12 in/min) | Stdev | 2 | 2 |
| | FM | AF | AF |
| 24 h PP peel | Ave | 85 | 82 |
| (oz/in, 12 in/min) | Stdev | 1 | 1 |
| | FM | AF | AF |
| RT SS shear | Shear 1 | 1,556 | 1,950 |
| (min, | Shear 2 | 2,247 | 10,000 |
| 0.5 in*0.5 in*1 Kg) | Shear 3 | 3,378 | 10,000 |
| | FM | AF & CF | AF & CF |
| 70 C. SS shear | Shear 1 | 10,000 | 10,000 |
| (min, | Shear 2 | 10,000 | 10,000 |
| 1 in*1 in*1 Kg) | Shear 3 | | |
| | FM | | |

### Examples 27 to 89

### Part A. (Pre-Emulsion Preparation)

First, the oil phase was prepared. Add monomer mixture and tackifier (see chemical A to M) in a glass or plastic jar and mix them until the tackifier(s) were totally dissolved. After that, add chain transfer agent, or/and crosslinkers, or/and oil soluble initiator (see chemical A1 to F1) into the oil phase and mix well. The weight ratio of each component based on 100 parts of monomer is provided in the formulation Table. The total amount of oil phase is also provided in the formulation Table.

Then, the aqueous phase was prepared by mixing water and surfactant in a beaker (see chemical A2 to F2). Finally, pre-emulsion was prepared by adding the oil phase slowly into the aqueous phase under mixing (400 rpm) followed by mixing for about 40 min to 1 h. Then the pre-emulsion was further processed with a Warring blender at speed 7 (~25,000 rpm) for about 1 min (model 7012S, warring company)

### Part B. (Polymerization)

First, charge the high shear mixed pre-emulsion into a glass jar. Then, if necessary, add water soluble initiators (see A3 to E3). After that, use N2 purge the jar for about 15 to 30 min. After that, put the jar in a water bath to carry out polymerization. The polymerization condition is shown in the formulation table.

After polymerization, the emulsion was cooled to room temperature, and NH3 was added to neutralize the emulsion to the desired pH of 4 to 7. The adhesive was then filtered into a container with a cheese cloth.

TABLE 14
Control Example (CE) 1 and EX-27-29

| | PSA ID | CE 1 | EX-27 | EX-28 | EX-29 |
|---|---|---|---|---|---|
| | Chemical | Ratio | Ratio | Ratio | Ratio |
| Oil phase ratio | | | | | |
| A | DAIB | 98.00 | 77.00 | 78.00 | 78.00 |
| B | OAIB | | 21.00 | | |
| C | IBOA | | | 20.00 | |
| D | IBOMA | | | | 20.00 |
| E | AA | 1.00 | 1.00 | 1.00 | 1.00 |
| F | MAA | 1.00 | 1.00 | 1.00 | 1.00 |
| G | P140 | 15.00 | 15.00 | 15.00 | 15.00 |
| A1 | HDDA | 0.060 | 0.060 | 0.060 | 0.060 |
| B1 | Vazo 88 | 0.15 | 0.15 | 0.15 | 0.15 |
| C1 | | | | | |
| Aqueous phase | AR-10 | 1.20 | 1.20 | 1.20 | 1.20 |
| ratio | | | | | |
| Water soluble | KPS | 0.20 | 0.20 | 0.20 | 0.20 |
| initiator ratio | | | | | |
| Addition (g) | Oil (g) | 95 | 95 | 95 | 95 |
| | Aqueous phase | | | | |
| A2 | AR-1025 (g) | 4.96 | 4.96 | 4.96 | 4.96 |
| B2 | H2O (g) | 65.5 | 65.5 | 65.5 | 65.5 |
| | Water soluble | | | | |
| | initiator | | | | |
| A3 | KPS (3%, g) | 5.51 | 5.51 | 5.51 | 5.51 |

| | |
|---|---|
| Polymerization | 60 C./12.5 h & 70 C./3 h |
| condition | |

TABLE 15
Control Example (CE) 1 and EX-27-29

| PSA ID | | CE 1 | EX-27 | EX-28 | EX-29 |
|---|---|---|---|---|---|
| High(er) Tg | OAIB | | 21 pt | | |
| monomer | IBOA | | | 20 pt | |
| | IBOMA | | | | 20 pt |
| PSA clarity | | Clear | Tiny haze | Clear | Clear |
| 24 h SS peel | Ave | 39 | 41 | 55 | 61 |
| (oz/in, | Stdev | 1 | 1 | 2 | 2 |
| 12 in/min) | FM | AF | AF | AF | AF |
| 24 h PP peel | Ave | 60 | 62 | 63 | 71 |
| (oz/in, | Stdev | 2 | 1 | 1 | 1 |
| 12 in/min) | FM | | | | |
| RT SS shear | Shear 1 | 220 | 10,000 | 2,381 | 10,000 |
| (min, | Shear 2 | 1,384 | 10,000 | 10,000 | 10,000 |
| 0.5 in*1 in*1 Kg) | Shear 3 | 1,646 | 10,000 | 10,000 | 10,000 |
| | FM | CF | | | |

TABLE 16

| | PSA ID | EX-30 | EX-31 | EX-32 |
|---|---|---|---|---|
| | Chemical | Ratio | Ratio | Ratio |
| Oil phase ratio | | | | |
| A | IOA | 66.00 | 41.00 | |
| B | OAIB | | | 47.00 |
| C | EHA | | | 30.00 |
| D | DAIB | | 25.00 | |
| E | MAA | 2.00 | 2.00 | 3.00 |
| F | CEA | 2.00 | 2.00 | |
| G | IBOA | 30.00 | 30.00 | 20.00 |
| H | P125 | 15.00 | 15.00 | |
| I | P100 | | | 15.00 |
| A1 | HDDA | 0.10 | 0.10 | 0.06 |
| B1 | Vazo 88 | 0.15 | 0.15 | |
| C1 | TDDM | | | 0.02 |
| D1 | AEBP | | | 0.10 |
| Aqueous phase | AR-10 | 1.50 | 1.50 | 2.00 |
| ratio | KPS | 0.25 | 0.25 | |
| | APS | | | 0.20 |
| Addition (g) | Oil (g) | 75 | 75 | 95 |
| | Aqueous phase | | | |
| A2 | AR-1025 (g) | 3.91 | 3.91 | 7.6 |
| B2 | H2O (g) | 50 | 50 | 60 |
| | Water soluble | | | |
| | initiator | | | |
| A3 | KPS (3%, g) | 5.44 | 5.44 | |
| B3 | APS (3%, g) | | | 5.51 |
| Polymerization | | 70 C./23 h | 70 C./23 h | 60 C./14 h & |
| condition | | | | 70 C./3 h |

TABLE 17

| PSA ID | | EX-30 | EX-31 | EX-32 |
|---|---|---|---|---|
| Tackifier | | P125 | P125 | P100 |
| High Tg | IBOA (pt) | 30 | 30 | 20 |
| monomer | | | | |
| 24 h SS peel | Ave | 87 | 88 | 72 |
| (oz/in, 12 in/min) | Stdev | 1 | 1 | 1 |
| | FM | AF | AF | |
| 24 h PP peel | Ave | 89 | 89 | 91 |
| (oz/in, 12 in/min) | Stdev | 1 | 2 | 2 |
| | FM | AF | AF | |
| RT SS shear | Shear 1 | 1,149 | 2,225 | 2,118 |
| (min, | Shear 2 | 2,524 | 10,000 | 3,379 |
| 0.5 in*0.5 in*1 Kg) | Shear 3 | 1,565 | 10,000 | 4,119 |
| | FM | | | |
| | Ave | 1,746 | 7,408 | 3,205 |

Note:
(1) All the room temperature shears are very high, since a very small contact area and heavy weight are used.

TABLE 18

| | | PSA ID | | | | |
|---|---|---|---|---|---|---|
| | | EX-33 | EX-34 | EX-35 | EX-36 | EX-37 |
| | Chemical | Ratio | Ratio | Ratio | Ratio | Ratio |
| Oil phase ratio | | | | | | |
| A | IOA | 56 | 46 | 46 | 41.00 | 41.00 |
| B | DAIB | 20 | 20 | 20 | 25.00 | 25.00 |
| C | MAA | 2 | 2 | 2 | 2.00 | 2.00 |
| D | CEA | 2 | 2 | 2 | 2.00 | 2.00 |
| E | IBOA | 20 | 20 | 20 | 30.00 | 20.00 |
| F | CHMA | | 10 | | | |
| G | IBMA | | | 5 | | |
| H | TBMA | | | 5 | | |
| I | NBMA | | | | | 10.00 |
| J | P125 | 15 | 15 | 15 | 15.00 | 15.00 |
| K | | | | | | |
| A1 | HDDA | 0.10 | 0.10 | 0.10 | 0.10 | 0.10 |
| B1 | Vazo 88 | 0.15 | 0.15 | 0.15 | 0.15 | 0.15 |
| Aqueous | AR-10 | 1.50 | 1.50 | 1.50 | 1.50 | 1.50 |
| phase ratio | | | | | | |
| Water soluble | KPS | 0.2 | 0.2 | 0.2 | 0.25 | 0.25 |
| intiator ratio | | | | | | |
| Addition (g) | Oil (g) | 75 | 75 | 75 | 75 | 75 |
| | Aqueous phase | | | | | |
| A2 | AR-1025 (g) | 3.91 | 3.91 | 3.91 | 3.91 | 3.91 |
| B2 | H2O (g) | 50 | 50 | 50 | 50 | 50 |
| | Water soluble | | | | | |
| | initiator | | | | | |
| A3 | KPS (3%, g) | 4.35 | 4.35 | 4.35 | 5.44 | 5.44 |
| Polymerization | 70 C./25 h | 70 C./25 h | 70 C./25 h | 70 C./25 h | 70 C./23 h | 70 C./23 h |
| condition | | | | | | |

TABLE 19

| PSA ID | | EX-33 | EX-34 | | EX-35 | | EX-36 | EX-37 | |
|---|---|---|---|---|---|---|---|---|---|
| Low Tg | IOA (pt) | 56 | 46 | | 46 | | 41 | 41 | |
| monomer | DAIB (pt) | 20 | 20 | | 20 | | 25 | 25 | |
| High Tg | Monomer | IBOA | IBOA/ | | IBOA/IBMA/ | | IBOA | IBOA/ | |
| monomer | | | CHMA | | TBMA | | | NBMA | |
| | Amount | 20 pt | 20/10 | pt | 20/5/5 | pt | 30 pt | 20/10 | pt |
| | (pt) | | | | | | | | |

| Tackifier | ID | P125 | P125 | | P125 | | P125 | P125 | |
|---|---|---|---|---|---|---|---|---|---|
| | Amount | 15 pt | 15 | pt | 15 | pt | 15 pt | 15 | pt |
| | (pt) | | | | | | | | |

| | | | | | | |
|---|---|---|---|---|---|---|
| PSA clarity | | Clear | Clear | Clear | Clear | Clear |
| 24 h SS peel | Ave | 82 | 93 | 93 | 88 | 73 |
| (oz/in, 12 | Stdev | 3 | 2 | 4 | 1 | 2 |
| in/min) | FM | AF | AF & | AF | AF | AF |
| | | | tiny CF | | | |
| 24 h PP peel | Ave | 78 | 66 | 74 | 89 | 84 |
| (oz/in, 12 | Stdev | 1 | 16 | 4 | 2 | 3 |
| in/min) | FM | AF | AF | AF | AF | AF |
| RT SS shear | Shear 1 | 1,670 | 9,597 | 4,276 | 10,000 | 1,572 |
| (min, 0.5 | Shear 2 | 1,743 | 10,000 | 7,241 | 2,225 | 1,156 |
| in*0.5 in*1 Kg) | Shear 3 | | | | 10,000 | 1,359 |
| | FM | | | | | |
| | Ave | 1,138 | 6,532 | 3,839 | 7,408 | 1,362 |
| 70 C. SS shear | Shear 1 | 10,000 | 10,000 | 10,000 | | |
| (min, | Shear 2 | 10,000 | 10,000 | 10,000 | | |
| 1 in*1 in*1 Kg) | Shear 3 | | | | | |
| | FM | | | | | |
| | Ave | | | | | |

TABLE 20

| | | PSA ID | | | | |
|---|---|---|---|---|---|---|
| | | EX-38 | EX-39 | EX-40 | EX-41 | EX-42 |
| | Chemical | Ratio | Ratio | Ratio | Ratio | Ratio |
| Oil phase ratio | | | | | | |
| A | IOA | 19 | 19 | 19 | 19 | 19 |
| B | DAIB | 60 | 60 | 60 | 60 | 60 |
| C | AA | 1 | 1 | 1 | 1 | 1 |
| D | IBOA | 20 | | | | |
| E | CHMA | | | | | 20 |
| F | IBMA | | | 20 | 10 | |
| G | TBA | | 20 | | | |
| H | TBMA | | | | 10 | |
| I | P125 | 15 | 15 | 15 | 15 | 15 |
| J | | | | | | |
| K | | | | | | |
| A1 | HDDA | 0.10 | 0.10 | 0.10 | 0.10 | 0.10 |
| B1 | Vazo 67 | 0.30 | 0.30 | 0.30 | 0.30 | 0.30 |
| C1 | | | | | | |
| D1 | | | | | | |
| Aqueous | AR-10 | 1.50 | 1.50 | 1.50 | 1.50 | 1.50 |
| phase ratio | | | | | | |
| Water soluble | | | | | | |
| intiator ratio | | | | | | |
| Addition (g) | Oil (g) | 75 | | | | |
| | Aqueous phase | | | | | |
| A2 | AR-1025 (g) | 3.91 | | | | |
| B2 | H2O (g) | 55 | | | | |
| | Water soluble | | | | | |
| | initiator | | | | | |
| A3 | KPS (3%, g) | 0 | | | | |
| Polymerization | Polymerization: | | | | | |
| condition | 70 C./23 h | | | | | |

TABLE 21

| PSA ID | | EX-38 | EX-39 | EX-40 | EX-41 | EX-42 |
|---|---|---|---|---|---|---|
| Low Tg monomer | IOA | 19 | 19 | 19 | 19 | 19 |
| | DAIB | 60 | 60 | 60 | 60 | 60 |
| High Tg monomer | Monomer | IBOA | TBA | IBMA | IBMA/ | CHMA |
| | | | | | TBMA | |
| | Amount | 20 pt | 20 pt | 20 pt | 10/10 pt | 20 pt |
| | (pt) | | | | | |
| PSA clarity | | Clear | Tiny | Clear | Clear | Clear |
| | | | haze | | | |
| 24 h SS peel | Ave | 65 | 57 | 66 | 65 | 66 |
| (oz/in, 12 in/min) | Stdev | 2 | 1 | 1 | 1 | 2 |
| | FM | AF | AF | AF | AF | AF |
| 24 h PP peel | Ave | 70 | 81 | 61 | 62 | 72 |
| (oz/in, 12 in/min) | Stdev | 1 | 1 | 0 | 0 | 0 |
| | FM | AF | AF & | AF | AF | AF |
| | | | tiny CF | | | |
| RT SS shear (min, | Shear 1 | 4,454 | 2,168 | 2,646 | 4,586 | 6,214 |
| 1 in*1 in*1 Kg) | Shear 2 | 6,279 | 2,330 | 3,094 | 6,697 | 7,151 |
| | Shear 3 | | | | | |
| | FM | | | | | |
| | Ave | 5,367 | 2,249 | 2,870 | 5,642 | 6,683 |

TABLE 22
EX-43 and EX-44

| | | EX-43 | EX-44 |
|---|---|---|---|
| | Chemical | Ratio | Ratio |
| Oil phase ratio | | | |
| A | IOA | 97.00 | 79.00 |
| B | AA | 1.50 | 1.50 |
| C | MAA | 1.50 | 1.50 |
| D | | | |
| E | CHMA | | 18.00 |
| F | | | |
| G | P125 | 12.00 | 12.00 |
| H | | | |
| I | | | |
| J | | | |
| K | | | |
| A1 | T-DDM | 0.02 | 0.02 |
| B1 | HDDA | 0.06 | 0.06 |
| C1 | AeBP | 0.10 | 0.10 |
| D1 | Vazo 88 | | |
| Aqueous phase ratio | KH-10 | 2.00 | 2.00 |
| | AR-10 | | |
| Water soluble intiator | KPS | 0.20 | 0.20 |
| ratio | | | |
| Addition (g) | Oil (g) | 95 | |
| | Aquoues phase | | |
| A2 | KH-1025 (g) | 7.6 | |
| B2 | AR-1025 (g) | | |
| A3 | H2O (g) | 59 | |
| | Water soluble initiator | | |
| | KPS (3%, g) | 5.65 | |
| Polymerization | 60 C./24 h | | |
| condition | | | |

TABLE 23

| PSA ID | | EX-43 | EX-44 |
|---|---|---|---|
| High Tg monomer | Monomer | N/A | CHMA |
| | Amount (pt) | | 18 pt |
| Tackifier | P125: Full hydrogenation & | | |
| | SP/125C | | |
| | Amount (pt) | 12 pt | 12 pt |
| PSA clarity | | | |
| Immediate SS peel | Ave | 50 | 55 |
| (oz/in, 12 in/min) | Stdev | 2 | 1 |
| | FM | AF | |
| Immediate PP peel | Ave | 85 | 76 |
| (oz/in, 12 in/min) | Stdev | 0 | 1 |
| | FM | | |
| RT SS shear (min, | Shear 1 | 53 | 144 |
| 0.5 in*0.5 in*1 Kg) | Shear 2 | 67 | 180 |
| | Shear 3 | | 182 |
| | FM | | |
| | Ave | | |

Note:
Based on our correlation study, adhesive with ~60 min shear (0.5 in*0.5 in*1 kg) will pass 10K min shear (1 in*1 in*500 g)

TABLE 24
Examples 45 and 46

| | PSA ID | EX-45 | EX-46 |
|---|---|---|---|
| | Chemical | Ratio | Ratio |
| Oil phase ratio | | | |
| A | OAIB | 68.50 | 68.50 |
| B | DAIB | 30.00 | 30.00 |
| C | IBOA | | |
| D | AA | 0.90 | 0.90 |
| E | MAA | 0.60 | 0.60 |
| F | P100 | | |
| G | P125 | 15.00 | 15.00 |
| H | P140 | | |
| I | | | |
| J | | | |
| K | | | |
| A1 | HDDA | 0.032 | 0.064 |
| B1 | AeBP | 0.125 | 0.125 |
| C1 | | | |
| D1 | | | |
| Aqueous phase ratio | BC-10 | 1.20 | 1.20 |
| Water soluble intiator | KPS | 0.20 | 0.20 |
| ratio | | | |

| | | |
|---|---|---|
| Addition (g) | Oil (g) | 75 |

Aqueous
phase

| | | |
|---|---|---|
| A2 | BC-1025 (g) | 3.6 |
| B2 | H2O (g) | 54.5 |
| | Aqueous | 4.35 |

initiator

| | | |
|---|---|---|
| A3 | KPS (3%, g) | 4.35 |

| | |
|---|---|
| Polymerization | 70 C/5 h. |

condition

TABLE 25

PSA ID

| | | |
|---|---|---|
| PSA clarity | EX-45 | EX-46 |

| | | | |
|---|---|---|---|
| 24 h SS peel | Ave | 55 | 51 |
| (oz/in, 8 in/min) | Stdev | 2 | 0 |
| | FM | | |
| 24 h PP peel | Ave | 88 | 66 |
| (oz/in, 8 in/min) | Stdev | 3 | 1 |
| | FM | AF & tiny CF | |
| RT SS shear | Shear 1 | 81 | 301 |
| (min, | Shear 2 | 89 | 283 |
| 0.5 in*0.5 in*1 Kg) | Shear 3 | | |
| | FM | | |

Note:
good shear. ~60 min shear (0.5 in*0.5 in*1 kg) can pass 10K min (1 in*1 in*500 g)

TABLE 26
Examples EX-47 to EX-53

| | | PSA ID | | | | | | |
|---|---|---|---|---|---|---|---|---|
| | | EX-47 | EX-48 | EX-49 | EX-50 | EX-51 | EX-52 | EX-53 |
| | Chemical | Ratio | Ratio | Ratio | Ratio | Ratio | Ratio | Ratio |
| Oil phase ratio | | | | | | | | |
| A | IOA | 97.70% | 98.00% | 97.70% | 97.70% | 97.70% | 97.70% | 97.70% |
| B | AA | 1.50% | 1.50% | 1.50% | 1.50% | 1.50% | 1.50% | 1.50% |
| C | MAA | 0.50% | 0.50% | 0.50% | 0.50% | 0.50% | 0.50% | 0.50% |
| D | DAAM | 0.30% | 0.00% | 0.30% | 0.30% | 0.30% | 0.30% | 0.30% |
| E | M100 | 15.00% | | | | | | |
| F | M115 | | 15.00% | | | | | 10.00% |
| G | M135 | | | 15.00% | | | | |
| H | Reg 7100 | | | | 15.00% | | | |
| I | Reg 7125 | | | | | 15.00% | | |
| J | Reg 6108 | | | | | | 15.00% | 5.00% |
| K | P100 | | | | | | | |
| A1 | HDDA | 0.10% | 0.10% | 0.10% | 0.10% | 0.10% | 0.10% | 0.10% |
| B1 | V88 | 0.10% | 0.10% | 0.10% | 0.10% | 0.10% | 0.10% | 0.10% |
| C1 | | | | | | | | |
| D1 | | | | | | | | |
| Aqueous | AR10 | 1.50% | 1.50% | 1.50% | 1.50% | 1.50% | 1.50% | 1.50% |
| phase ratio | | | | | | | | |
| Water soluble | KPS | 0.20% | 0.20% | 0.20% | 0.20% | 0.20% | 0.20% | 0.20% |
| intiator ratio | | | | | | | | |
| Addition (g) | Oil (g) | 75 | | | | | | |
| | Aqueous phase | | | | | | | |
| A2 | AR-1025 (g) | 3.92 | | | | | | |
| B2 | H2O (g) | 53 | | | | | | |
| | Water soluble | | | | | | | |
| | initiator | | | | | | | |
| A3 | KPS (3%, g) | 4.35 | | | | | | |

| | |
|---|---|
| Polymerization | 60 C./14 h & 70 C./3.5 h |
| condition | |

TABLE 27

| ID | | EX-47 | EX-48 | EX-49 | EX-50 | EX-51 | EX-52 | EX-53 |
|---|---|---|---|---|---|---|---|---|
| Tackifier | | M100: | M115: | M135: | Reg | Reg | Reg | P100/M115: |
| 15 pt | | 15 pt | 15 pt | 7100: | 7125: | 6108: | 5/10 pt | |
| | | | | 15 pt | 15 pt | 15 pt | | |
| Tackifier | | M100 | M115 | M135 | Reg | Reg | Reg | P100/M115 |
| | | | | 7100 | 7125 | 6108 | | |
| PSA clarity | | Clear | Clear | Some | Clear | Clear | Clear | Clear |
| | | | | hazy | | | | |
| 24 h SS peel | Ave | 50 | 52 | 58 | 47 | 53 | 46 | 51 |
| (oz/in, 12 in/min) | Stdev | 1 | 1 | 2 | 1 | 1 | 0 | 0 |
| | FM | AF | AF | AF | AF | AF | AF | AF |
| 24 h PP peel | Ave | 60 | 71 | 80 | 53 | 64 | 55 | 70 |
| (oz/in, 12 in/min) | Stdev | 1 | 1 | 1 | 1 | 0 | 1 | 1 |
| | FM | AF | AF | AF | AF | AF | AF | AF |
| RT SS shear | Shear 1 | 50 | 78 | 323 | 160 | 768 | 502 | 255 |
| (min, 0.5 | Shear 2 | 62 | 92 | 347 | 144 | 335 | 335 | 339 |
| in*0.5 in*1 kg) | Shear 3 | 136 | 129 | 182 | 254 | 475 | 276 | 230 |
| | FM | CF | CF | CF | CF | CF | CF | CF |

| | | | | | | | |
|---|---|---|---|---|---|---|---|
| Average shear | 83 | 100 | 284 | 186 | 526 | 371 | 275 |
| (0.5*1*1 kg) | | | | | | | |

TABLE 28

| | PSA ID | EX-54 | EX-55 | EX-56 | EX-57 |
|---|---|---|---|---|---|
| | Chemical | Ratio | Ratio | Ratio | Ratio |
| Oil phase ratio | | | | | |
| A | IOA | 87.70% | 87.70% | 87.70% | 87.70% |
| B | CHMA | 10.00% | | | 10.00% |
| C | TBMA | | 10.00% | | |
| D | IBMA | | | 10.00% | |
| E | IBOA | | | | |
| F | AA | 1.50% | 1.50% | 1.50% | 1.50% |
| G | MAA | 0.50% | 0.50% | 0.50% | 0.50% |
| H | DAAM | 0.30% | 0.30% | 0.30% | 0.30% |
| I | Reg 7125 | 15.00% | 15.00% | 15.00% | |
| J | Reg 6108 | | | | 15.00% |
| K | P100 | | | | |
| A1 | HDDA | 0.10% | 0.10% | 0.10% | 0.10% |
| B1 | V88 | 0.10% | 0.10% | 0.10% | 0.10% |
| C1 | | | | | |
| D1 | | | | | |
| Aqueous phase | AR10 | 1.50% | 1.50% | 1.50% | 1.50% |
| ratio | | | | | |
| Water soluble | KPS | 0.20% | 0.20% | 0.20% | 0.20% |
| initiator ratio | | | | | |
| Addition (g) | Oil phase | 75 | | | |
| A2 | AR1025 | 3.91 | | | |
| B2 | H2O | 53 | | | |
| | Water | | | | |
| | soluble | | | | |
| | initiator | | | | |
| A3 | KPS | 4.35 | | | |
| Polymerization | 60 C./12 h & | | | | |
| condition | 70 c./5.5 h | | | | |

TABLE 29

| ID | | EX-54 | EX-55 | EX-56 | EX-57 | EX-58 | EX-59 |
|---|---|---|---|---|---|---|---|
| Monomer | | CHMA: | TBMA: | IBMA: | CHMA: | CHMA: | IBOA/CHMA: |
| | | 10 | 10 | 10 | 10 | 10 | 10/10 |
| Tackifier | | Reg 7125 | Reg 7125 | Reg | Reg | P100/Reg | P100/Reg |
| | | | | 7125 | 6108 | 6108: 5/10 | 6108: 5/10 |
| 24 h SS peel | Ave | 63 | 60 | 56 | 57 | 53 | 67 |
| (oz/in, 12 in/min) | Stdev | 1 | 1 | 1 | 2 | 1 | 1 |
| | FM | AF | AF | AF | AF | AF | AF |
| 24 h PP peel | Ave | 61 | 61 | 64 | 56 | 59 | 63 |
| (oz/in, 12 in/min) | Stdev | 1 | 1 | 1 | 1 | 1 | 2 |
| | FM | AF | AF | AF | AF | AF | AF |
| RT SS shear | Shear 1 | 673 | 236 | 541 | 577 | 704 | 1614 |
| (min, 0.5 | Shear 2 | 774 | 584 | 603 | 619 | 680 | 1720 |
| in*0.5 in*1 kg) | Shear 3 | 578 | | 1080 | 742 | 629 | 1900 |
| | FM | CF | CF | CF | CF | CF | CF |

TABLE 30
EX-60 to EX-66

| | | PSA ID | | | | | | |
|---|---|---|---|---|---|---|---|---|
| | | EX-60 | EX-61 | EX-62 | EX-63 | EX-64 | EX-65 | EX-66 |
| | Chemical | Ratio | Ratio | Ratio | Ratio | Ratio | Ratio | Ratio |
| Oil phase ratio | | | | | | | | |
| A | DAIB | 99.00 | 69.00 | 79.00 | 69.00 | 69.00 | 69.00 | 69.00 |
| B | CHMA | | | 20.00 | 10.00 | | | |
| C | TBMA | | | | | 10.00 | | |
| D | TBA | | | | | | | 10.00 |
| E | IBMA | | | | | | 10.00 | |
| F | NBMA | | | | | | | |
| G | IBOA | | 30.00 | | 20.00 | 20.00 | 20.00 | 20.00 |
| H | AA | 1.00 | 1.00 | 1.00 | 1.00 | 1.00 | 1.00 | 1.00 |
| I | | | | | | | | |
| J | Reg 7125 | 18.00 | 18.00 | 18.00 | 18.00 | 18.00 | 18.00 | 18.00 |
| K | | | | | | | | |
| A1 | HDDA | 0.10 | 0.10 | 0.10 | 0.10 | 0.10 | 0.10 | 0.10 |
| B1 | Vazo 67 | 0.20 | 0.20 | 0.20 | 0.20 | 0.20 | 0.20 | 0.20 |
| C1 | | | | | | | | |
| D1 | | | | | | | | |
| Aqueous | AR-10 | 1.50 | 1.50 | 1.50 | 1.50 | 1.50 | 1.50 | 1.50 |
| phase ratio | | | | | | | | |
| Water soluble | | | | | | | | |
| intiator ratio | | | | | | | | |
| Addition (g) | Oil (g) | 75 | | | | | | |
| | Aqueous phase | | | | | | | |
| A2 | AR-1025 (g) | 3.81 | | | | | | |
| B2 | H2O (g) | 55 | | | | | | |
| A3 | Water soluble | | | | | | | |
| | initiator | | | | | | | |

| | |
|---|---|
| Polymerization | 70 C./20 h |
| condition | |

TABLE 31

| PSA ID | | EX-60 | EX-61 | EX-62 | EX-63 | EX-64 | EX-65 | EX-66 |
|---|---|---|---|---|---|---|---|---|
| High Tg | Monomer | none | IBOA | CHMA | IBOA/ | IBOA/ | IBOA/ | IBOA/ |
| monomer | | | | | CHMA | TBMA | IBMA | TBA |
| | Amount | N/A | 30 pt | 20 pt | 20/ | 20/ | 20/ | 20/ |
| | (pt) | | | | 10 pt | 10 pt | 10 pt | 10 pt |
| 24 h SS peel | Ave | 51 | 67 | 64 | 68 | 69 | 63 | 88 |
| (oz/in, 12 in/min) | Stdev | 0 | 1 | 0 | 1 | 2 | 1 | 3 |
| | FM | Ghost | AF | AF | AF | AF | AF | AF |
| 24 h PP peel | Ave | 43 | 78 | 62 | 71 | 31 | 64 | 77 |
| (oz/in, 12 in/min) | Stdev | 0 | 5 | 1 | 5 | 4 | 16 | 1 |
| | FM | AF | AF & | AF & | AF | AF | AF | AF |
| | | | Tiny CF | tiny CF | | | | |
| RT SS shear | Shear 1 | 1 | 100 | 163 | 263 | 703 | 164 | 224 |
| (min, 0.5 | Shear 2 | 1 | 134 | 164 | 264 | 792 | 170 | 197 |
| in*0.5 in*1 Kg) | Shear 3 | | | | | | | |
| | FM | | | | | | | |
| | Ave | 1 | 117 | 164 | 264 | 748 | 167 | 211 |
| RT SS shear | Shear 1 | | 6,095 | | 10,000 | | | |
| (min, | Shear 2 | | 7,299 | | 10,000 | | | |
| 1 in*1 in*1 Kg) | Shear 3 | | | | | | | |
| | FM | | | | | | | |
| | Ave | | | | | | | |

Note:
Based on our correlation study, adhesive with ~60 min shear (0.5 in*0.5 in*1 kg) will pass 10K min shear (1 in*1 in*500 g)

TABLE 32
EX-67 to EX-69

| | PSA ID | EX-67 | EX-68 | EX-69 |
|---|---|---|---|---|
| | Chemical | Ratio | Ratio | Ratio |
| Oil phase ratio | | | | |
| A | EHA | 78.00% | | |
| B | IOA | | 78.00% | 78.00% |
| C | IBOA | 20.00% | 20.00% | 20.00% |
| D | AA | 1.00% | 1.00% | 1.00% |
| E | MAA | 1.00% | 1.00% | 1.00% |
| F | M135 | 15.00% | | |
| G | Reg7125 | | 15.00% | |
| H | Reg 3102 | | | 15.00% |
| A1 | HDDA | 0.10% | 0.10% | 0.08% |
| B1 | Vazo 88 | 0.12% | 0.12% | 0.12% |
| C1 | | | | |
| Aqueous phase | AR-10 | 1.60% | 1.60% | 1.60% |
| ratio | KPS | 0.20% | 0.20% | 0.20% |
| Addition (g) | Oil (g) | 75 | 75 | 75 |
| | Aqueous phase | | | |
| A2 | AR-1025 (g) | 4.17 | 4.17 | 4.17 |
| B2 | H2O (g) | 51 | 51 | 51 |
| | Water soluble initiator | | | |
| C2 | KPS (3%, g) | 4.35 | 4.35 | 4.35 |
| | Polymerization condition | 60 C./24 h & | 60 C./24 h & | 60 C./24 h |
| | | 70 C./4 h | 70 C./4 h | |

TABLE 33

| PSA ID | | EX-67 | EX-68 | EX-69 |
|---|---|---|---|---|
| Tackifier: Amount | | M135: 15pt | Reg 7125: 15 pt | Reg 3102: 15 pt |
| Low Tg monomer | | EHA | IOA | |
| AA/MAA | | 1/1 pt | 1/1 pt | |
| 24 h SS peel (oz/in, | Ave | 65 | 70 | 69 |
| 12 in/min) | Stdev | 1 | 1 | 0 |
| | FM | AF | AF | Clean |
| 24 h PP peel (oz/in, | Ave | 58 | 68 | 40 |
| 12 in/min) | Stdev | 1 | 2 | 1 |
| | FM | AF | AF | Clean |
| RT SS shear (min, | Shear 1 | 327 | 686 | 1,764 |
| 0.5 in*0.5 in*1 kg) | Shear 2 | 270 | 2,304 | 1,870 |
| | Shear 3 | 676 | 2,900 | 2,742 |
| | FM | | | CF |

Based on our shear correlation study, adhesive with ~60 min shear (0.5 in*0.5 in*1 kg) can pass 10K min shear (1 in*1 in*500 g)

TABLE 34
EX-70 to EX-76

| | | PSA ID | | | | | | |
|---|---|---|---|---|---|---|---|---|
| | | EX-70 | EX-71 | EX-72 | EX-73 | EX-74 | EX-75 | EX-76 |
| | Chemical | Ratio | Ratio | Ratio | Ratio | Ratio | Ratio | Ratio |
| Oil phase ratio | | | | | | | | |
| A | DAIB | 99.00 | 69.00 | 79.00 | 69.00 | 69.00 | 69.00 | 69.00 |
| B | CHMA | | | 20.00 | 10.00 | | | |
| C | TBMA | | | | | 10.00 | | |
| D | TBA | | | | | | | 10.00 |
| E | IBMA | | | | | | 10.00 | |
| F | NBMA | | | | | | | |
| G | IBOA | | 30.00 | | 20.00 | 20.00 | 20.00 | 20.00 |
| H | AA | 1.00 | 1.00 | 1.00 | 1.00 | 1.00 | 1.00 | 1.00 |
| I | | | | | | | | |
| J | Reg 7125 | 18.00 | 18.00 | 18.00 | 18.00 | 18.00 | 18.00 | 18.00 |
| K | | | | | | | | |
| A1 | HDDA | 0.10 | 0.10 | 0.10 | 0.10 | 0.10 | 0.10 | 0.10 |
| B1 | Vazo 67 | 0.20 | 0.20 | 0.20 | 0.20 | 0.20 | 0.20 | 0.20 |
| C1 | | | | | | | | |
| D1 | | | | | | | | |
| Aqueous | AR-10 | 1.50 | 1.50 | 1.50 | 1.50 | 1.50 | 1.50 | 1.50 |
| phase ratio | | | | | | | | |
| Water soluble | | | | | | | | |
| intiator ratio | | | | | | | | |
| Addition (g) | Oil (g) | 75 | | | | | | |
| | Aqueous phase | | | | | | | |
| A2 | AR-1025 (g) | 3.81 | | | | | | |
| B2 | H2O (g) | 55 | | | | | | |
| A3 | Water soluble | | | | | | | |
| | initiator | | | | | | | |

| | |
|---|---|
| Polymerization | 70 C./20 h |
| condition | |

TABLE 35
EX-70 to EX-76

| PSA ID | | EX-70 | EX-71 | EX-72 | EX-73 | EX-74 | EX-75 | EX-76 |
|---|---|---|---|---|---|---|---|---|
| High Tg monomer | Monomer | | IBOA | CHMA | IBOA/ | IBOA/ | IBOA/ | IBOA/ |
| | | | | | CHMA | TBMA | IBMA | TBA |
| | Amount | N/A | 30 pt | 20 pt | 20/ | 20/ | 20/ | 20/ |
| | (pt) | | | | 10 pt | 10 pt | 10 pt | 10 pt |
| 24 h SS peel | Ave | 51 | 67 | 64 | 68 | 69 | 63 | 88 |
| (oz/in, 12 in/min) | Stdev | 0 | 1 | 0 | 1 | 2 | 1 | 3 |
| | FM | Ghost | AF | AF | AF | AF | AF | AF |
| 24 h PP peel | Ave | 43 | 78 | 62 | 71 | 31 | 64 | 77 |
| (oz/in, 12 in/min) | Stdev | 0 | 5 | 1 | 5 | 4 | 16 | 1 |
| | FM | AF | AF & | AF & | AF | AF | AF | AF |
| | | | Tiny CF | tiny CF | | | | |
| RT SS shear | Shear 1 | 1 | 100 | 163 | 263 | 703 | 164 | 224 |
| (min, 0.5 | Shear 2 | 1 | 134 | 164 | 264 | 792 | 170 | 197 |
| in*0.5 in*1 Kg) | Shear 3 | | | | | | | |
| | FM | | | | | | | |
| | Ave | 1 | 117 | 164 | 264 | 748 | 167 | 211 |
| RT SS shear | Shear 1 | | 6,095 | | 10,000 | | | |
| (min, | Shear 2 | | 7,299 | | 10,000 | | | |
| 1 in*1 in*1 Kg) | Shear 3 | | | | | | | |
| | FM | | | | | | | |
| | Ave | | | | | | | |

Note:
Based on our correlation study, adhesive with ~60 min shear (0.5 in*0.5 in*1 kg) will pass 10K min shear (1 in*1 in*500 g)

TABLE 36
EX-77 to EX-79

| | Adhesive ID | EX-77 | EX-78 | EX-79 |
|---|---|---|---|---|
| | Chemical | Ratio | Ratio | Ratio |
| Oil phase ratio | | | | |
| A | OAIB | 43.50 | 48.50 | 48.50 |
| B | EHA | 30.00 | 30.00 | 30.00 |
| C | AA | 1.50 | 1.50 | 1.50 |
| D | MAA | 1.50 | 1.50 | 1.50 |
| E | TBCHA | 25.00 | 20.00 | 20.00 |
| F | P100 | 7.50 | 15.00 | 15.00 |
| G | P125 | 7.50 | | |
| H | | | | |
| A1 | T-DDM | 0.02 | 0.02 | 0.02 |
| B1 | HDDA | 0.06 | 0.06 | 0.06 |
| C1 | AeBP | 0.10 | 0.10 | 0.10 |
| D1 | | | | |
| Aqueous phase ratio | KH-10 | 2.00 | 2.00 | |
| | AR-10 | | | 2.00 |
| Water soluble initiator | APS | 0.20 | 0.20 | 0.20 |
| ratio | | | | |
| Addition (g) | Addition (g) | | | |
| | Oil (g) | 95 | | |
| | Aquoues phase | | | |
| A2 | KH-1025 (g) | 7.6 | | |
| B2 | AR-1025 (g) | | | |
| C2 | H2O (g) | 60 | | |
| | Water soluble initiator | | | |

| | | |
|---|---|---|
| A3 | APS (3%, g) | 5.51 |

Polymerization condition
60 C./14 h & 70 C./3 h

TABLE 37
EX-77 to EX-79

| Adhesive ID | | EX-77 | EX-78 | EX-79 |
|---|---|---|---|---|
| High Tg monomer | Monomer | TBCHA | TBCHA | TBCHA |
| | Amount (pt) | 25 pt | 20 pt | 20 pt |
| Tackifier | P100 (pt) | 7.5 pt | 15 pt | 15 pt |
| | P125 (pt) | 7.5 pt | | |
| Surfactant | | KH-10 | KH-10 | AR-10 |
| 24 h SS peel (oz/in, | Ave | 90 | 69 | 59 |
| 12 in/min) | Stdev | 2 | 1 | 0 |
| | FM | AF | AF | AF |
| 24 h PP peel (oz/in, | Ave | 82 | 90 | 81 |
| 12 in/min) | Stdev | 1 | 0 | 2 |
| | FM | AF | AF | AF |
| RT SS shear (min, | Shear 1 | 609 | 418 | 4,286 |
| 0.5 in*0.5 in*1 Kg) | Shear 2 | 653 | 425 | 9,829 |
| | Shear 3 | 669 | 450 | 2,279 |
| | FM | CF | CF | CF |
| | Ave | | | |

Note:
Based on our shear correlation study, adhesive with about 60 min shear (0.5 in*0.5 in*1 kg) can pass 10K min shear (1 in*1 in*500 g)

TABLE 38
EX-80 to EX-83

| | Adhesive ID | EX-80 | EX-81 | EX-82 | EX-83 |
|---|---|---|---|---|---|
| | Chemical | Ratio | Ratio | Ratio | Ratio |
| Oil phase ratio | | | | | |
| A | OAIB | 48.50 | 48.50 | 48.50 | 38.50 |
| B | DAIB | 30.00 | 30.00 | 30.00 | 30.00 |
| C | AA | 1.00 | 1.00 | 1.50 | 1.50 |
| D | MAA | 1.00 | 1.00 | 1.50 | 1.50 |
| E | IBOMA | 15.00 | | | |
| F | TBCHMA | | 15.00 | | |
| G | TBCHA | | | 20.00 | 30.00 |
| H | | | | | |
| I | P125 | 15.00 | 15.00 | 15.00 | 15.00 |
| A1 | T-DDM | 0.02 | 0.02 | 0.02 | 0.02 |
| B1 | HDDA | 0.06 | 0.06 | 0.06 | 0.06 |
| C1 | AeBP | 0.10 | 0.10 | 0.10 | 0.10 |
| D1 | Vazo 88 | | | | |
| Aqueous phase | KH-10 | 1.50 | 1.50 | 2.00 | 2.00 |
| ratio | AR-10 | 0.50 | 0.50 | | |
| Water soluble | APS | 0.20 | 0.20 | 0.20 | 0.20 |
| initiator ratio | | | | | |
| Addition (g) | Oil (g) | 95 | 95 | 95 | 95 |
| | Aquoues phase | | | | |
| A2 | KH-1025 (g) | 5.7 | 5.7 | 7.6 | 5.7 |
| B2 | AR-1025 (g) | 1.9 | 1.9 | | 1.9 |
| C2 | H2O (g) | 60 | 60 | 60 | 60 |
| | Water soluble | | | | |
| | initiator | | | | |
| A3 | APS (g) | 5.51 | 5.51 | 5.51 | 5.51 |
| | Polymerization condition | | | | |
| | 60 C./12 h & | 60 C./12 h & | 60 C./12 h & | 60 C./14 h & | 60 C./14 h & |
| | 70 C./3 h | 70 C./3 h | 70 C./3 h | 70 C./3 h | 70 C./3 h |

TABLE 39
EX-80 to EX-83

| Adhesive ID | | EX-80 | EX-81 | EX-82 | EX-83 |
|---|---|---|---|---|---|
| High Tg | Monomer | IBOMA | TBCHMA | TBCHA | TBCHA |
| monomer | Amount (pt) | 15 pt | 15 pt | 20 pt | 30 pt |
| Tackifier | ID | P125 | P125 | P125 | P125 |
| | Amount (pt) | 15 pt | 15 pt | 15 pt | 15 pt |
| PSA clarity | | | | | |
| 24 h SS peel | Ave | 81 | 79 | 71 | 92 |
| (oz/in, 12 in/min) | Stdev | 0 | 1 | 1 | 1 |
| | FM | AF | AF | AF | AF |
| 24 h PP peel | Ave | 89 | 84 | 93 | 100 |
| (oz/in, 12 in/min) | Stdev | 1 | 0 | 2 | 2 |
| | FM | AF | AF | AF | AF |
| RT SS shear | Shear 1 | 648 | 626 | 475 | 1,710 |
| (min, | Shear 2 | 665 | 515 | 543 | 1,371 |
| 0.5 in*0.5 in*1 Kg) | Shear 3 | 640 | 643 | 568 | 1,770 |
| | FM | | | CF | CF |
| | Ave | | | | |

TABLE 40
EX-84 to EX-89

| | Ratio | EX-84 | EX-85 | EX-86 | EX-87 | EX-88 | EX-89 |
|---|---|---|---|---|---|---|---|
| Oil phase ratio | | | | | | | |
| A | IOA | 79.00% | 79.00% | 79.00% | 79.00% | 73.50% | 73.50% |
| B | TBMA | 10.00% | | | | | |
| C | TBA | | | | | | |
| D | IBMA | 10.00% | | | | | |
| E | IBOA | | 20.00% | | 20.00% | 25.00% | 25.00% |
| F | IBOMA | | | | | | |
| G | CHMA | | | 20.00% | | | |
| H | AA | 1.00% | 1.00% | 1.00% | 1.00% | 0.60% | 0.60% |
| I | MAA | | | | | 0.90% | 0.90% |
| J | TH160 | 10.00% | 10.00% | 10.00% | 10.00% | | |
| K | TO125 | | | | | 5.00% | |
| L | Reg 6108 | | | | 5.00% | | |
| | Reg 7125 | | | | | 10.00% | 10.00% |
| | Pensel | | | | | | 5.00% |
| | D160 | | | | | | |
| A1 | HDDA | 0.10% | 0.10% | 0.10% | 0.10% | 0.10% | 0.10% |
| B1 | AeBP | 0.12% | 0.12% | 0.12% | 0.12% | | |
| C1 | Vazo 67 | 0.30% | 0.30% | 0.30% | 0.30% | 0.20% | 0.20% |
| D1 | Luperox | | | | | 0.10% | 0.10% |
| | A75 | | | | | | |
| Aqueous | AR-10 | 1.50% | 1.50% | 1.50% | 1.50% | 1.50% | 1.50% |
| phase ratio | | | | | | | |
| Water soluble | | | | | | | |
| intiator ratio | | | | | | | |
| Addition (g) | T_Oil (g) | 75 | 75 | 75 | 75 | 75 | 75 |
| | Aqueous phse | | | | | | |
| A2 | AR1025 | 4.09 | 4.09 | 4.09 | 4.09 | 3.91 | 3.91 |
| | (25%, g) | | | | | | |
| B2 | H2O | 55 | 55 | 55 | 55 | 53 | 53 |
| A3 | Water soluble | | | | | | |
| | initiator | | | | | | |
| Polymerization | 70 C./24 h | 70 C./24 h | 70 C./24 h | 70 C./24 h | 70 C./24 h | 70 C./22 h | 70 C./22 h |
| condition | | | | | | | |

TABLE 41
EX-84 to EX-89

| PSA ID | | EX-84 | EX-85 | EX-86 | EX-87 | EX-88 | EX-89 |
|---|---|---|---|---|---|---|---|
| 24 h SS peel | Ave | 48 | 52 | 50 | 61 | 71 | 78 |
| (oz/in, 12 in/min) | Stdev | 1 | 2 | 3 | 2 | 0 | 1 |
| | FM | clean | clean | clean | clean | AF | AF |
| 24 h PP peel | Ave | 51 | 60 | 55 | 68 | 72 | 77 |
| (oz/in, 12 in/min) | Stdev | 1 | 1 | 1 | 2 | 2 | 4 |
| | FM | clean | clean | clean | clean | AF | AF |
| RT SS shear | Shear 1 | 4,999 | 2,242 | 1,034 | 2,773 | 4,385 | 2,525 |
| (min, | Shear 2 | 5,216 | 2,581 | 10,000 | 3,036 | 5,175 | 2,751 |
| 1 in*1 in*1 Kg) | Shear 3 | | | | | | |
| | FM | | | | | | |
| | Ave | | | | | | |

This disclosure is not limited to the above-described embodiments but is to be controlled by the limitations set forth in the following claims and any equivalents thereof. This disclosure may be suitably practiced in the absence of any element not specifically disclosed herein.

1. A composition comprising:
an acrylic polymer comprising monomer units of at least one of an alkyl acrylate or alkyl methacrylate, wherein alkyl has at least 8 carbon atoms, and at least 0.5 percent by weight of monomer units comprising a carboxylic acid, sulfonic acid, or phosphonic acid, based on the total weight of monomer units in the acrylic polymer;
a first tackifier;
an emulsifier; and
water;
wherein if the first tackifier is an aromatic hydrocarbon resin and has an aliphatic:aromatic hydrogen ratio or aliphatic:(unsaturated and aromatic) hydrogen ratio in a range from 75 to 80 as determined by proton nuclear magnetic resonance spectroscopy, at least one of the first tackifier is present in an amount of not more than 15.0 parts per 100 parts of the acrylic polymer or the monomer units comprise at least 15 percent by weight of an alkyl acrylate or an alkyl methacrylate in which alkyl has at least 10 carbon atoms;
wherein at least one of the following conditions is met:
wherein alkyl has at least 10 carbon atoms, and wherein the acrylic polymer further comprises at least one of second monomer units of at least one of a C₄-C₉ alkyl acrylate or C₄-C₉ alkyl methacrylate or third monomer units of a high T_{g} monomer that when polymerized provides a homopolymer having a glass transition temperature of at least 20° C.; or
wherein the composition comprises a second tackifier which differs from the first tackifier in at least one of molecular weight, softening point as determined using a ring and ball apparatus, or aliphatic:aromatic hydrogen ratio or aliphatic:(unsaturated and aromatic) hydrogen ratio; or
wherein the acrylic polymer includes third monomer units of a high T_{g} monomer that when polymerized provides a homopolymer having a glass transition temperature of at least 20° C., wherein the high Tg monomer has an alkyl group with at least four carbon atoms; or
wherein the first tackifier is an aromatic hydrocarbon resin with at least one of a aliphatic:aromatic hydrogen ratio or aliphatic:(unsaturated and aromatic) hydrogen ratio of less than 50 or a molecular weight of at least 1200 grams per mole.

2. The composition of claim 1, wherein alkyl has at least 10 carbon atoms.

3. The composition of claim 1, wherein the acrylic polymer further comprises monomer units of a second monomer comprising at least one of a C₄-C₉ alkyl acrylate or C₄-C₉ alkyl methacrylate.

4. The composition of claim 1, wherein the acrylic polymer further comprises monomer units of a high T_{g} monomer that when polymerized provides a homopolymer having a glass transition temperature of at least 20° C., wherein the high Tg monomer has an alkyl group with at least four carbon atoms.

5. The composition of claim 1, wherein the acrylic polymer further comprises monomer units of a polar monomer including at least one ketone, amide, amine, alcohol, or a combination thereof.

6. The composition of claim 1, wherein the acrylic polymer further comprises monomer units of an acrylate or methacrylate having more than one acrylate or methacrylate group.

7. The composition of claim 1, wherein the first tackifier has a molecular weight of at least 1200 grams per mole.

8. The composition of claim 1, wherein the composition is an emulsion, and wherein the emulsion comprises droplets comprising both the tackifier and the acrylic polymer.

9. The composition of claim 1, further comprising a base.

10. The composition of claim 1, packaged in a spray container.

11. The composition of claim 1, wherein the first tackifier is a hydrogenated aromatic hydrocarbon resin.

12. The composition of claim 1, wherein the first tackifier has an aliphatic:aromatic hydrogen ratio or aliphatic:(unsaturated and aromatic) hydrogen ratio of not more than 34 as determined by proton nuclear magnetic resonance spectroscopy, and wherein the composition comprises the second tackifier, and wherein the second tackifier has an aliphatic:aromatic hydrogen ratio or aliphatic:(unsaturated and aromatic) hydrogen ratio of greater than 34 as determined by proton nuclear magnetic resonance spectroscopy.

13. A process for making the composition of claim 1, the method comprising:
combining the at least one tackifier and the at least one of an alkyl acrylate or alkyl methacrylate to form a solution;
combining the solution with the water and the emulsifier; and
polymerizing the at least one of an alkyl acrylate or alkyl methacrylate to form an emulsion with droplets that include both the acrylic polymer and the tackifier.

14. A method of making a bonded article comprising a first substrate and a second substrate, the method comprising:
applying the composition of claim 1 on at least one of the first substrate or the second substrate; and
adhering the first substrate and the second substrate using the emulsion.

15. The method of claim 14, wherein applying comprises spraying.
